(19) United States
(12) Patent Application Publication
(10) Pub. No.: US 2016/0096985 A1
(43) Pub. Date: Apr. 7, 2016

(54) ADHESIVES CONTAINING A RESIN, A KRAFT LIGNIN, AND A SURFACTANT AND METHODS FOR MAKING AND USING SAME

(71) Applicant: Georgia-Pacific Chemicals LLC, Atlanta, GA (US)

(72) Inventors: James H. Knight, Conyers, GA (US); David F. Townsend, Grayson, GA (US); Feng Jing, Snellville, GA (US); Irving D. Sand, Ellenwood, GA (US)

(73) Assignee: Georgia-Pacific Chemicals LLC, Atlanta, GA (US)

(21) Appl. No.: 14/875,114

(22) Filed: Oct. 5, 2015

Related U.S. Application Data
(60) Provisional application No. 62/060,841, filed on Oct. 7, 2014.

(51) Int. Cl. C09J 197/00

(52) U.S. Cl. CPC C09J 197/005

(57) ABSTRACT

Adhesives containing an aldehyde-based resin, a kraft lignin, and a surfactant and methods for making and using same are provided. In one or more embodiments, the adhesive can include an aldehyde-based resin; a kraft lignin; a surfactant; an alkaline compound; and water. The adhesive can have a viscosity of about 500 cP to about 5,000 cP, at a temperature of about 25° C. In one example, the adhesive can include about 20 wt % to about 40 wt % of the aldehyde-based resin, about 1 wt % to about 15 wt % of the kraft lignin, about 0.05 wt % to about 2 wt % of the surfactant, about 0.5 wt % to about 10 wt % of the alkaline compound, and about 45 wt % to about 70 wt % of water, where all weight percent values are based on a combined weight of the aldehyde-based resin, the kraft lignin, the surfactant, the alkaline compound, and the water.

### CROSS-REFERENCE TO RELATED APPLICATION

This application claims priority to U.S. Provisional Patent Application No. 62/060,841, filed on Oct. 7, 2014, which is incorporated by reference herein.

### BACKGROUND

1. Field

Embodiments described generally relate to adhesives and methods for making and using same. More particularly, such embodiments relate to adhesives containing an aldehyde-based resin, a kraft lignin, and a surfactant and methods for making and using same.

2. Description of the Related Art

The production of lignocellulose composite products requires a binder or an adhesive to bond the discrete sheets, veneers, particulates, fibers, or other substrates to one another. Typical lignocellulose composite products include plywood, oriented strand board (OSB), particleboard, and other composites products. Conventional adhesives used in the production of these composite products frequently contain formaldehyde-based resins, such as urea-formaldehyde (UF), melamine-formaldehyde (MF), melamine-urea-formaldehyde (MUF), or phenol-formaldehyde (PF).

There is a desire to incorporate renewable polyphenolics into these adhesives. One renewable polyphenolic is lignin. While these formaldehyde-based resins produce finished products having desirable properties, such as internal bond strength, in the final composite product, the viscosity of these formaldehyde-based resins can be insufficiently unstable when combined with lignin. For example, in plywood production, a consistent layer of adhesive is needed between each veneer layer. Often, however, the viscosity of the adhesive increases from the point in time the adhesive is produced and the point in time the adhesive is used in the production of the plywood to cause inconsistencies across the adhesive layer.

There is a need, therefore, for adhesives containing an aldehyde-based resin and a lignin having improved viscosity stability and methods for making and using same.

### SUMMARY

Adhesives containing an aldehyde-based resin, a kraft lignin, and a surfactant and methods for making and using same are provided. In one or more embodiments, the adhesive can include an aldehyde-based resin, a kraft lignin, a surfactant, an alkaline compound, and water. The adhesive can have a viscosity of about 500 cP to about 5,000 cP at a temperature of about 25° C. In at least one example, the adhesive can include about 20 wt % to about 40 wt % of the aldehyde-based resin, about 1 wt % to about 15 wt % of the kraft lignin, about 0.05 wt % to about 2 wt % of the surfactant, about 0.5 wt % to about 10 wt % of the alkaline compound, and about 45 wt % to about 70 wt % of water, where all weight percent values are based on a combined weight of the aldehyde-based resin, the kraft lignin, the surfactant, the alkaline compound, and the water. In at least one other example, the adhesive can include about 20 wt % to about 40 wt % of a phenol-formaldehyde resin, about 1 wt % to about 10 wt % of a kraft lignin, about 0.05 wt % to about 1 wt % of a lignosulfonate, about 0.5 wt % to about 5 wt % of an alkaline compound, and about 50 wt % to about 65 wt % of water, where all weight percent values are based on a combined weight of the phenol-formaldehyde resin, the kraft lignin, the surfactant, the alkaline compound, and the water. In some examples, the adhesive can also have a viscosity of about 500 cP to about 4,000 cP at a temperature of about 25° C., for a period of time of at least 1 day, and wherein the period of time starts when the adhesive is initially produced.

In one or more embodiments, a resinated furnish can include a plurality of lignocellulose substrates and an adhesive. The adhesive can include about 20 wt % to about 40 wt % of an aldehyde-based resin, about 1 wt % to about 15 wt % of a kraft lignin, about 0.05 wt % to about 2 wt % of a surfactant, about 0.5 wt % to about 10 wt % of an alkaline compound, and about 45 wt % to about 70 wt % of water, where all weight percent values are based on a combined weight of the aldehyde-based resin, the kraft lignin, the surfactant, the alkaline compound, and the water. The adhesive can have a viscosity of about 500 cP to about 5,000 cP at a temperature of about 25° C.

### DETAILED DESCRIPTION

It has been surprisingly and unexpectedly discovered that combining one or more kraft lignins, one or more surfactants, e.g., lignosulfonates, and optionally, one or more other components with one or more aldehyde-based resins provides an adhesive with a stabilized viscosity over time. Surprisingly, the adhesives that contain the one or more aldehyde-based resins, the one or more kraft lignins, and the one or more surfactants have more stabilized viscosities than adhesives of the same composition but without the surfactant. In one or more examples, the adhesive can include one or more aldehyde-based resins, one or more kraft lignins, one or more surfactants, one or more alkaline compounds, and water and the adhesive can have a viscosity of about 500 cP to about 5,000 cP at a temperature of about 25° C. In some examples, the adhesive can include about 20 wt % to about 40 wt % of the aldehyde-based resin, about 1 wt % to about 15 wt % of the kraft lignin, about 0.05 wt % to about 5 wt % of the surfactant, about 0.5 wt % to about 10 wt % of the alkaline compound, and about 45 wt % to about 70 wt % of water, where all weight percent values are based on the combined weight of the aldehyde-based resin, the kraft lignin, the surfactant, the alkaline compound, and water. The water in the adhesive can be initially present as a component of the aldehyde-based resin, the kraft lignin, the surfactant, the alkaline compound, and/or added as a separate component to produce the adhesive.

In some examples, in addition to the aldehyde-based resin, the kraft lignin, the surfactant, the alkaline compound, and the water, the adhesive can also include one or more extenders, one or more fillers, one or more salts, or any mixture thereof. For example, the adhesive can include up to about 20 wt %, up to about 15 wt %, up to about 12 wt %, up to about 10 wt %, up to about 8 wt %, or up to about 6 wt % of the extender, based on the combined weight of the aldehyde-based resin, the kraft lignin, the surfactant, the alkaline compound, and the water. In another example, the adhesive can include up to about 20 wt %, up to about 15 wt %, up to about 12 wt %, up to about 10 wt %, up to about 8 wt %, or up to about 6 wt % of the filler, based on the combined weight of the aldehyde-based resin, the kraft lignin, the surfactant, the alkaline compound, and the water. In another example, the adhesive can include up to about 10 wt %, up to about 8 wt %, up to about 6 wt %, up to about 5 wt %, up to about 4 wt %, up to about 3 wt %, or up to about 2 wt % of the salt, where all weight percent values are based on the combined weight of the aldehyde-based resin, the kraft lignin, the surfactant, the alkaline compound, and water. In other examples, the adhesive can include up to about 10 wt % of the extender, up to about 10 wt % of the filler, and/or up to about 5 wt % of the salt, where all weight percent values are based on the combined weight of the aldehyde-based resin, the kraft lignin, the surfactant, the alkaline compound, the extender, the filler, the salt, and the water. For example, the adhesive can include about 1 wt % to about 10 wt % of the extender, about 1 wt % to about 10 wt % of the filler, and about 0.1 wt % to about 5 wt % of the salt, where all weight percent values are based on the combined weight of the aldehyde-based resin, the kraft lignin, the surfactant, the alkaline compound, the extender, the filler, the salt, and the water. The water in the adhesive can also be initially present as a component of the extender, the filler, and/or the salt.

In some examples, the adhesive can include about 20 wt % to about 40 wt % of the aldehyde-based resin, about 1 wt % to about 15 wt % of the kraft lignin, about 0.05 wt % to about 3 wt % of the surfactant, about 0.5 wt % to about 10 wt % of the alkaline compound, up to about 10 wt % of the extender, up to about 10 wt % of the filler, up to about 3 wt % of the salt, and about 45 wt % to about 70 wt % of water, where all weight percent values are based on the combined weight of the aldehyde-based resin, the kraft lignin, the surfactant, the alkaline compound, any extender, any filler, any salt, and the water. In other examples, the adhesive can include about 20 wt % to about 40 wt % of the aldehyde-based resin, about 1 wt % to about 15 wt % of the kraft lignin, about 0.05 wt % to about 2 wt % of the surfactant, about 0.5 wt % to about 10 wt % of the alkaline compound, up to about 10 wt % of the extender, up to about 10 wt % of the filler, up to about 3 wt % of the salt, and about 45 wt % to about 70 wt % of water, where all weight percent values are based on the combined weight of the aldehyde-based resin, the kraft lignin, the surfactant, the alkaline compound, any extender, any filler, any salt, and the water.

In some examples, the adhesive can include about 20 wt % to about 40 wt % of the aldehyde-based resin, about 1 wt % to about 15 wt % of the kraft lignin, about 0.05 wt % to about 2 wt % of the surfactant, about 0.5 wt % to about 10 wt % of the alkaline compound, about 0.1 wt % to about 10 wt % of the extender, and about 45 wt % to about 70 wt % of the water, where all weight percent values are based on the combined weight of the aldehyde-based resin, the kraft lignin, the surfactant, the alkaline compound, the extender, and the water. In other examples, the adhesive can include about 20 wt % to about 40 wt % of the aldehyde-based resin, about 1 wt % to about 15 wt % of the kraft lignin, about 0.05 wt % to about 2 wt % of the surfactant, about 0.5 wt % to about 10 wt % of the alkaline compound, about 0.1 wt % to about 10 wt % of the filler, and about 45 wt % to about 70 wt % of the water, where all weight percent values are based on the combined weight of the aldehyde-based resin, the kraft lignin, the surfactant, the alkaline compound, the filler, and the water. In other examples, the adhesive can include about 20 wt % to about 40 wt % of the aldehyde-based resin, about 1 wt % to about 15 wt % of the kraft lignin, about 0.05 wt % to about 2 wt % of the surfactant, about 0.5 wt % to about 10 wt % of the alkaline compound, about 0.1 wt % to about 5 wt % of the salt, and about 45 wt % to about 70 wt % of the water, where all weight percent values are based on the combined weight of the aldehyde-based resin, the kraft lignin, the surfactant, the alkaline compound, the salt, and the water. In other examples, the adhesive can include about 20 wt % to about 40 wt % of the aldehyde-based resin, about 1 wt % to about 15 wt % of the kraft lignin, about 0.05 wt % to about 2 wt % of the surfactant, about 0.5 wt % to about 10 wt % of the alkaline compound, about 1 wt % to about 10 wt % of the extender, about 1 wt % to about 10 wt % of the filler, about 0.1 wt % to about 5 wt % of the salt, and about 45 wt % to about 70 wt % of the water, where all weight percent values are based on the combined weight of the aldehyde-based resin, the kraft lignin, the surfactant, the alkaline compound, the extender, the filler, the salt, and the water.

In some examples, the adhesive can include about 1 wt % to about 15 wt % of the kraft lignin, about 0.05 wt % to about 2 wt % of the surfactant, about 0.5 wt % to about 10 wt % of the alkaline compound, and about 45 wt % to about 70 wt % of water, where all weight percent values are based on a solids weight of the aldehyde-based resin. In another example, when the adhesive includes the extender, the filler, and/or the salt, the adhesive can include about 1 wt % to about 10 wt % of the kraft lignin, about 0.05 wt % to about 1 wt % of the surfactant, about 0.5 wt % to about 5 wt % of the alkaline compound, up to about 10 wt % of the extender, up to about 10 wt % of the filler, up to about 5 wt % of the salt, and about 50 wt % to about 65 wt % of water, where all weight percent values are based on the solids weight of the aldehyde-based resin.

The adhesive that includes the aldehyde-based resin, the kraft lignin, the surfactant, the alkaline compound, and water can have a solids content of about 30 wt %, about 35 wt %, or about 40 wt % to about 45 wt %, about 50 wt %, or about 55 wt %. For example, the adhesive that includes the aldehyde-based resin, the kraft lignin, the surfactant, the alkaline compound, and water can have a solids content of about 37 wt % to about 53 wt %, about 39 wt % to about 51 wt %, about 41 wt % to about 49 wt %, about 42 wt % to about 44 wt %, about 42 wt % to about 46 wt %, or about 44 wt % to about 46 wt %. In another example, the adhesive that includes the aldehyde-based resin, the kraft lignin, the surfactant, the alkaline compound, water, and at least one of the extender, the filler, and the salt can have a solids content about 30 wt %, about 35 wt %, or about 40 wt % to about 45 wt %, about 50 wt %, or about 55 wt %. In another example, the adhesive that includes the aldehyde-based resin, the kraft lignin, the surfactant, the alkaline compound, water, and at least one of the extender, the filler, and the salt can have a solids content of about 37 wt % to about 53 wt %, about 39 wt % to about 51 wt %, about 41 wt % to about 49 wt %, about 42 wt % to about 45 wt %, about 42 wt % to about 43 wt %, about 43 wt % to about 45 wt %, or about 42 wt % to about 46 wt %.

As used herein, the solids weight, solids concentration, or solids content of a solution or solid/liquid mixture, e.g., the adhesive and the aldehyde-based resin, as understood by those skilled in the art, can be measured by determining the weight loss upon heating a small sample, e.g., about 5 grams to about 8 grams of the mixture, to a suitable temperature, e.g., about 105° C., and a time sufficient to remove the liquid therefrom. By measuring the weight of the sample before and after heating, the percent solids in the sample can be directly calculated or otherwise estimated.

The adhesive can have a viscosity of about 500 cP, about 600 cP, about 700 cP, about 800 cP, about 900 cP, about 1,000 cP, about 1,100 cP, about 1,200 cP, about 1,300 cP, about 1,400 cP, about 1,500 cP, about 1,600 cP, about 1,700 cP, about 1,800 cP, about 1,900 cP, or about 2,000 cP, to about 2,200 cP, about 2,400 cP, about 2,600 cP, about 2,800 cP, about 3,000 cP, about 3,200 cP, about 3,400 cP, about 3,600 cP, about 3,800 cP, about 4,000 cP, about 4,200 cP, about 4,400 cP, about 4,600 cP, about 4,800 cP, about 5,000 cP, about 5,200 cP, about 5,400 cP, about 5,600 cP, about 5,800 cP, or about 6,000 cP at a temperature of about 25° C. For example, the adhesive can have a viscosity of about 500 cP to about 6,000 cP, about 500 cP to about 5,000 cP, about 500 cP to about 4,000 cP, about 500 cP to about 3,500 cP, about 500 cP to about 3,000 cP, about 500 cP to about 2,500 cP, about 500 cP to about 2,000 cP, about 500 cP to about 1,500 cP, about 500 cP to about 1,000 cP, about 1,000 cP to about 6,000 cP, about 1,500 cP to about 5,000 cP, about 1,500 cP to about 4,000 cP, about 1,500 cP to about 3,500 cP, about 2,000 cP to about 3,300 cP, about 2,000 cP to about 3,100 cP, about 2,000 cP to about 3,000 cP, about 2,000 cP to about 2,900 cP, about 2,000 cP to about 2,700 cP, or about 2,000 cP to about 2,500 cP at a temperature of about 25° C. In other examples, the adhesive can have a viscosity of about 500 cP, about 600 cP, about 800 cP, about 1,000 cP, about 1,200 cP, about 1,400 cP, about 1,600 cP, about 1,800 cP, or about 2,000 cP, to less than 2,200 cP, less than 2,400 cP, less than 2,600 cP, less than 2,800 cP, less than 3,000 cP, less than 3,200 cP, less than 3,400 cP, less than 3,600 cP, less than 3,800 cP, or less than 4,000 cP at a temperature of about 25° C.

The viscosity of the various compositions discussed and described herein, e.g., the adhesive, can be determined using a viscometer at a temperature of about 25° C. For example, an LV Series Brookfield viscometer, commercially available from Brookfield Company, Inc., with a number 3 or 4 LV Series spindle, can be used to measure the viscosity. About 300 mL of a sample can be placed into a 400 mL beaker and the temperature of the sample can be adjusted to about 25° C. The spindle can be initially set to rotate at a speed of 30 rpms. The clutch on the viscometer can be depressed and the viscometer can be turned on. After turning on the viscometer the clutch can be released to allow the spindle to rotate through the sample for 90 seconds. The clutch can then be depressed to stabilize the position of the indicator over the scale and the viscometer can be stopped. A reading can be taken and if the reading does not fall between “20” and “80” on the scale, another spindle, e.g., switch from a number 3 to a number 4 spindle or vice versa, and/or the rotation speed of the spindle can be changed until a reading between “20” and “80” on the scale is observed. The viscosity of the sample in (cP) is equal to the “Scale reading X Factor”. The “Scale reading X Factor” is dependent on the spindle number and rotation speed and is obtained by consulting the factor finder supplied with the viscometer. The viscosity can be reported in cP as a Brookfield LVF measurement including the spindle number used, rotation speed (rpm), and the sample temperature. Unless otherwise noted, the viscosity of the various compositions discussed and described herein were measured with a Model LVT Brookfield viscometer equipped with a number 3 LV Series spindle at a temperature of about 25° C. unless otherwise noted. The spindle rotation was initially set to 30 rpm and if adjustments were required to achieve a reading between “20” and “80” on the scale the spindle and/or the rotational speed of the spindle were adjusted as required.

The adhesive can have a viscosity of about 500 cP, about 600 cP, about 700 cP, about 800 cP, about 900 cP, about 1,000 cP, about 1,100 cP, about 1,200 cP, about 1,300 cP, about 1,400 cP, about 1,500 cP, about 1,600 cP, about 1,700 cP, about 1,800 cP, about 1,900 cP, or about 2,000 cP, to about 2,200 cP, about 2,400 cP, about 2,600 cP, about 2,800 cP, about 3,000 cP, about 3,200 cP, about 3,400 cP, about 3,600 cP, about 3,800 cP, about 4,000 cP, about 4,200 cP, about 4,400 cP, about 4,600 cP, about 4,800 cP, about 5,000 cP, about 5,200 cP, about 5,400 cP, about 5,600 cP, about 5,800 cP, or about 6,000 cP at a temperature of about 25° C. For example, the adhesive can have a viscosity of about 500 cP, about 600 cP, about 700 cP, about 800 cP, about 900 cP, about 1,000 cP, about 1,100 cP, about 1,200 cP, about 1,300 cP, about 1,400 cP, about 1,500 cP, about 1,600 cP, about 1,700 cP, about 1,800 cP, about 1,900 cP, or about 2,000 cP, to about 2,200 cP, about 2,400 cP, about 2,600 cP, about 2,800 cP, about 3,000 cP, about 3,200 cP, about 3,400 cP, about 3,600 cP, about 3,800 cP, about 4,000 cP, about 4,200 cP, about 4,400 cP, about 4,600 cP, about 4,800 cP, about 5,000 cP, about 5,200 cP, about 5,400 cP, about 5,600 cP, about 5,800 cP, or about 6,000 cP at a solids content of about 42 wt % to about 46 wt % and at a temperature of about 25° C. For example, the adhesive can have a viscosity of about 500 cP to about 6,000 cP, about 500 cP to about 5,000 cP, about 500 cP to about 4,000 cP, about 500 cP to about 3,500 cP, about 500 cP to about 3,000 cP, about 500 cP to about 2,500 cP, about 500 cP to about 2,000 cP, about 500 cP to about 1,500 cP, about 500 cP to about 1,000 cP, about 1,000 cP to about 6,000 cP, about 1,500 cP to about 5,000 cP, about 1,500 cP to about 4,000 cP, about 1,500 cP to about 3,500 cP, about 2,000 cP to about 3,300 cP, about 2,000 cP to about 3,100 cP, about 2,000 cP to about 3,000 cP, about 2,000 cP to about 2,900 cP, about 2,000 cP to about 2,700 cP, or about 2,000 cP to about 2,500 cP at a solids content about 42 wt % to about 46 wt % and at a temperature of about 25° C. In other examples, the adhesive can have a viscosity of about 500 cP, about 600 cP, about 800 cP, about 1,000 cP, about 1,200 cP, about 1,400 cP, about 1,600 cP, about 1,800 cP, or about 2,000 cP, to less than 2,200 cP, less than 2,400 cP, less than 2,600 cP, less than 2,800 cP, less than 3,000 cP, less than 3,200 cP, less than 3,400 cP, less than 3,600 cP, less than 3,800 cP, or less than 4,000 cP at a solids content of about 42 wt % to about 46 wt % and at a temperature of about 25° C.

The adhesive can have a viscosity of about 500 cP, about 750 cP, or about 1,000 cP to about 3,500 cP, about 4,000 cP, or about 5,000 cP at a temperature of about 25° C., for a period of time of about 1 day, about 1.5 days, about 2 days, about 2.5 days, about 3 days, or about 4 days to about 5 days, about 7 days, about 10 days, about 15 days, about 20 days, or more, where the period of time is based on when the adhesive is initially made or otherwise produced. For example, the adhesive can have a viscosity of about 500 cP, about 750 cP, or about 1,000 cP to about 3,500 cP, about 4,000 cP, or about 5,000 cP at a temperature of about 25° C., for a period of time of at least 1 day, at least 1.5 days, at least 2 days, at least 2.5 days, at least 3 days, or at least 4 days to about 5 days, about 7 days, about 10 days, about 15 days, about 20 days, or more, where the period of time is based on when the adhesive is initially made or otherwise produced. In another example, the adhesive can have a viscosity of about 500 cP, about 750 cP, or about 1,000 cP to about 3,500 cP, about 4,000 cP, or about 5,000 cP at a temperature of about 25° C., for a period of time of about 1 day to about 20 days, where the period of time is based on when the adhesive is initially made or otherwise produced. In another example, the adhesive can have a viscosity of about 600 cP to about 3,600 cP at a temperature of about 25° C., for a period of time of about 1 day to about 20 days, where the period of time is based on when the adhesive is initially made or otherwise produced. In another example, the adhesive can have a viscosity of about 600 cP to about 3,000 cP at a temperature of about 25° C., for a period of time of about 1 day to about 20 days, where the period of time is based on when the adhesive is initially made or otherwise produced.

In some examples, the adhesive can have a viscosity of about 1,500 cP to about 3,500 cP at a temperature of about 25° C., for a period of time of about 1 day to about 20 days, where the period of time is based on when the adhesive is initially made or otherwise produced. In other examples, the adhesive can have a viscosity of about 500 cP, about 700 cP, about 900 cP, about 1,100 cP, about 1,300 cP, or about 1,500 cP to about 2,500 cP, about 2,700 cP, about 2,900 cP, about 3,100 cP, about 3,300 cP, about 3,500 cP, about 4,000 cP, about 4,500 cP, about 5,000 cP, or about 5,500 cP at a temperature of about 25° C., for a period of time of about 1 day to about 20 days, where the period of time is based on when the adhesive is initially made or otherwise produced. In other examples, the adhesive can have a viscosity of about 1,600 cP to about 3,600 cP at a temperature of about 25° C., for a period of time of about 1 day to about 20 days, where the period of time is based on when the adhesive is initially made or otherwise produced. In other examples, the adhesive can have a viscosity of about 1,600 cP to about 3,000 cP at a temperature of about 25° C., for a period of time of about 1 day to about 20 days, where the period of time is based on when the adhesive is initially made or otherwise produced. In another example, the adhesive can have a viscosity of about 500 cP, about 600 cP, about 700 cP, about 800 CP, about 900 cP, about 1,000 cP, about 1,100 cP, about 1,200 cP, about 1,300 cP, about 1,400 cP, or about 1,500 cP to about 2,500 cP, about 2,700 cP, about 2,900 cP, about 3,100 cP, about 3,300 cP, about 3,500 cP, about 3,600 cP, or about 3,700 cP at a solids content of about 42 wt % to about 46 wt % and at a temperature of about 25° C., for a period of time of about 1 day, about 1.5 days, about 2 days, about 2.5 days, about 3 days, or about 4 days to about 5 days, about 7 days, about 10 days, about 15 days, about 20 days, or more, where the period of time is based on when the adhesive is initially made or otherwise produced. The adhesive can be maintained at a temperature of about 20° C. to about 30° C., such as about 25° C., from the time the adhesive is produced to a period of time of about 1 day to about 20 days or more.

In another example, the adhesive can have a secondary viscosity at a temperature of about 25° C. of greater than an initial viscosity to less than 150% of the initial viscosity, where the secondary viscosity is measured 24 hours after the adhesive is initially made or otherwise produced. For example, the adhesive can have a secondary viscosity at a temperature of about 25° C. of greater than an initial viscosity to less than 140%, less than 135%, less than 130%, less than 125%, less than 120%, less than 115%, less than 110%, or less than 105% of the initial viscosity. In some examples, the adhesive can have a secondary viscosity at a temperature of about 25° C. of greater than an initial viscosity to less than 130% of the initial viscosity. In other examples, the adhesive can have a secondary viscosity at a temperature of about 25° C. of greater than an initial viscosity to less than 120% of the initial viscosity.

In other examples, the adhesive can have an initial viscosity of about 500 cP to about 3,500 cP at a temperature of about 25° C., for a period of time of about 1 day to about 20 days, where the period of time starts when the adhesive is initially produced. The adhesive can be maintained at a temperature of about 20° C. to about 30° C., such as about 25° C., during the period of time. In some examples, the adhesive can have a secondary viscosity of greater than an initial viscosity to less than 150% of the initial viscosity, where the secondary viscosity is measured 24 hours from the time of producing of the adhesive at a temperature of about 25° C. The adhesive can be maintained at a temperature of about 20° C. to about 30° C., such as about 25° C., from the time of producing of the adhesive to a period of time of about 1 day to about 20 days later.

The adhesive can have a pH of about 9, about 9.5, about 10, or about 10.5 to about 11, about 11.5, about 12, about 12.5, or about 13 at a temperature of about 25° C. For example, the adhesive can have a pH of about 9.7 to about 10.7, about 10 to about 12.4, about 10 to about 11, about 10.5 to about 11.5, about 11 to about 12.4, about 11.7 to about 12.4, or about 10.7 to about 11.7 at a temperature of about 25° C. In another example, the adhesive can have a pH of about 9.7 to about 10.7, about 10 to about 12.4, about 10 to about 11, about 10.5 to about 11.5, about 11 to about 12.4, about 11.7 to about 12.4, or about 10.7 to about 11.7 at a temperature of about 25° C., when the adhesive has a solids concentration of about 42 wt % to about 46 wt %. In another example, the adhesive can have a pH of at least 9, at least 9.3, at least 9.5, at least 9.7, at least 10, at least 10.3, at least 10.5, at least 10.7, or at least 11 to about 11.3, about 11.5, about 11.7, about 12, or about 12.5 at a temperature of about 25° C., when the adhesive has a solids concentration of about 42 wt % to about 46 wt %.

Illustrative aldehyde-based resins can include, but are not limited to, a phenol-aldehyde resin, a urea-aldehyde resin, a melamine-aldehyde resin, a resorcinol-aldehyde resin, a phenol-resorcinol-aldehyde resin, a phenol-urea-aldehyde resin, a melamine-urea-aldehyde resin, a phenol-melamine-aldehyde resin, or any mixture thereof.

The aldehyde compound in the aldehyde-based resin can include one or more substituted aldehyde compounds, one or more unsubstituted aldehyde compounds, or any mixture of substituted and/or unsubstituted aldehyde compounds. Illustrative aldehyde compounds can include, but are not limited to, aldehydes having the chemical formula RCHO, where R is hydrogen or a hydrocarbyl group. Illustrative hydrocarbyl groups can include 1 carbon atom to about 8 carbon atoms. Suitable aldehyde compounds can also include the so-called masked aldehydes or aldehyde equivalents, such as acetals or hemiacetals. Illustrative aldehyde compounds can include, but are not limited to, formaldehyde, paraformaldehyde, cinnamaldehyde, tolualdehyde, acetaldehyde, propionaldehyde, butyraldehyde, furfural, benzaldehyde, retinaldehyde, glyoxal, malondialdehyde, succindialdehyde, glutaraldehyde, phthaldehyde, derivatives thereof, or any mixture thereof. Still other suitable formaldehyde compounds can include formaldehyde present in a prepolymer or pre-condensate such as urea-formaldehyde precondensate (UFC). In at least one embodiment, the aldehyde compound can include formaldehyde.

When the aldehyde is or includes formaldehyde, the aldehyde-based resin can include, but is not limited to, a phenol-formaldehyde (PF) resin, a urea-formaldehyde (UF) resin, a melamine-formaldehyde (MF) resin, a resorcinol-formaldehyde (RF) resin, a phenol-resorcinol-formaldehyde (PRF) resin, a phenol-urea-formaldehyde (PUF) resin, a melamine-urea-formaldehyde (MUF) resin, a phenol-melamine-formaldehyde (PMF) resin, or any mixture thereof.

Referring to resins that include phenol or the reaction product of phenol and an aldehyde compound, the phenolic compound can include phenol, one or more substituted phenol compounds, one or more unsubstituted phenol compounds, or any combination or mixture of substituted and/or unsubstituted phenol compounds. In one example, the phenolic component can include phenol itself (monohydroxybenzene). Illustrative substituted phenolic compounds can include, but are not limited to, alkyl-substituted phenols such as the cresols and xylenols; cycloalkyl-substituted phenols such as cyclohexyl phenol; alkenyl-substituted phenols; aryl-substituted phenols such as p-phenyl phenol; alkoxy-substituted phenols such as 3,5-dimethyoxyphenol; aryloxy phenols such as p-phenoxy phenol; halogen-substituted phenols such as p-chlorophenol, or any mixture thereof. Dihydric phenols such as catechol, resorcinol, hydroquinone, bisphenol A and bisphenol F also can also be used. For example, the phenolic compound can include, but is not limited to, resorcinol, phenol, catechol, hydroquinone, pyrogallol, 5-methylresorcinol, 5-ethylresorcinol, 5-propylresorcinol, 4-methylresorcinol, 4-ethylresorcinol, 4-propylresorcinol, resorcinol monobenzoate, resorcinol monosinate, resorcinol diphenyl ether, resorcinol monomethyl ether, resorcinol monoacetate, resorcinol dimethyl ether, phloroglucinol, benzoylresorcinol, resorcinol rosinate, alkyl substituted resorcinol, aralkyl substituted resorcinol, 2-methylresorcinol, phloroglucinol, 1,2,4-benzenetriol, 3,5-dihydroxybenzaldehyde, 2,4-dihydroxybenzldehyde, 4-ethylresorcinol, 2,5-dimethylresorcinol, 5-methylbenzene-1,2,3-triol, 3,5-dihydroxybenzyl alcohol, 2,4,6-trihydroxytoluene, 4-chlororesorcinol, 2′,6′-dihydroxyacetophenone, 2′,4′-dihydroxyacetophenone, 3′,5′-dihydroxyacetophenone, 2,4,5-trihydroxybenzaldehyde, 2,3,4-trihydroxybenzaldehyde, 2,4,6-trihydroxybenzaldehyde, 3,5-dihydroxybenzoic acid, 2,4-dihydroxybenzoic acid, 2,6-dihydroxybenzoic acid, 1,3-dihydroxynaphthalene, 2′,4′-dihydroxypropiophenone, 2′,4′-dihydroxy-6′-methylacetophenone, 1-(2,6-dihydroxy-3-methylphenyl)ethanone, 3-methyl 3,5-dihydroxybenzoate, methyl 2,4-dihydroxybenzoate, gallacetophenone, 2,4-dihydroxy-3-methylbenzoic acid, 2,6-dihydroxy-4-methylbenzoic acid, methyl 2,6-dihydroxybenzoate, 2-methyl-4-nitroresorcinol, 2,4,5-trihydroxybenzoic acid, 3,4,5-trihydroxybenzoic acid, 2,3,4-trihydroxybenzoic acid, 2,4,6-trihydroxybenzoic acid, 2-nitrophloroglucinol, or any mixture thereof. In at least one example, the phenolic compound can include phenol, resorcinol, or a mixture thereof. The phenolic compound can include any combination or mixture of two or more phenolic compounds combined with one another and/or added independent of one another to the reaction mixture.

The phenol-aldehyde resin, when mixed with water, can form an aqueous solution, dispersion, suspension, or other mixture that can have a pH from about 7, about 8, about 9, or about 10 to about 11, about 12, or about 13. For example, the aqueous phenol-aldehyde resin can form an aqueous solution, dispersion, suspension, or other mixture that can have a pH of about 8 to about 11, about 9 to about 10.5, about 9.5 to about 11.5, about 10 to about 12, about 10.5 to about 12.5, about 10.5 to about 11, about 10.6 to about 12, about 11 to about 12, or about 11.5 to about 12.5.

The aqueous aldehyde-based resin, e.g., aqueous phenol-formaldehyde resin, can have a solids or non-volatiles content from a low of about 25 wt %, about 30 wt %, about 25 wt %, or about 40 wt % to a high of about 45 wt %, about 50 wt %, about 55 wt %, about 60 wt %, or about 65 wt %. The aqueous aldehyde-based resin, e.g., aqueous phenol-formaldehyde resin, can have an alkalinity, i.e., contains an alkaline compound, from a low of about 0.5%, about 1%, about 2%, about 3%, about 4%, or about 5% to a high of about 6%, about 8%, about 10%, about 13%, or about 15%, based on the weight of the aqueous aldehyde-based resin. The alkaline compound can be sodium hydroxide, potassium hydroxide, or a mixture thereof, for example. If the aqueous aldehyde-based resin includes the alkaline compound, the alkaline compound can be the same compound or a different as compared to the alkaline compound further discussed below that can be used to adjust the pH of the adhesive.

The aqueous aldehyde-based resin, e.g., aqueous phenol-formaldehyde resin, can have a viscosity from a low of about 100 cP, about 300 cP, about 500 cP, or about 600 cP to a high of about 700 cP, about 800 cP, about 900 cP, about 1,000 cP, about 1,200 cP, about 1,500 cP, about 1,800 cP, about 2,000 cP, about 2,200 cP, about 2,500 cP, about 2,700 cP, or about 3,000 cP at a temperature of about 25° C., when the aqueous aldehyde-based resin has a solids concentration of about 42 wt % to about 46 wt %.

The aldehyde-based resin can be a thermosetting resin. For example, if the aldehyde-based resin includes the phenol-formaldehyde resin, the phenol-formaldehyde resin can be a phenol-formaldehyde resole resin having a molar ratio of formaldehyde to phenol of 1 or greater. The aldehyde-based resin can be a thermoplastic resin. For example, if the aldehyde-based resin includes the phenol-formaldehyde resin, the phenol-formaldehyde resin can be a phenol-formaldehyde novolac resin having a molar ratio of formaldehyde to phenol of less than 1. In some examples, the adhesive can include one or more one or more phenol-formaldehyde resins as the aldehyde-based resin. In some examples, the aldehyde-based resin does not include urea. In other examples, the aldehyde-based resin does not include melamine. In still other examples, the aldehyde-based resin does not include urea or melamine. In at least one example, the aldehyde-based resin can include a phenol-formaldehyde resin, e.g., resole and/or novolac, which does not include urea or melamine

Considering phenol-aldehyde resole resins in particular, a molar ratio of the aldehyde compound to the phenolic compound in the phenol-aldehyde resole resin can be about 1.05:1, about 1.1:1, about 1.2:1, about 1.4:1, about 1.6:1, about 1.8:1, or about 2:1 to about 1.2:1, about 2.5:1, about 2.7:1, about 3:1, about 3.5:1, or about 4:1. For example, the molar ratio of the aldehyde compound to the phenolic compound can be about 1.5:1 to about 3:1, about 1.9:1 to about 2.6:1, about 2:1 to about 2.5:1, about 2.1:1 to about 2.6:1, about 2.2:1 to about 2.5:1, about 2:1 to about 2.3:1, or about 2.3:1 to about 2.5:1.

Several PF resins that can be used to make the adhesives or the composite products can include an aqueous phenol-formaldehyde resin, such as GP REST-BOND® 5772 plywood neat resin, commercially available from Georgia-Pacific Chemical LLC, a phenol-formaldehyde resin powder, such as WOODWELD® 190C42 spray-dried OSB adhesive, commercially available from Georgia-Pacific Chemical LLC, or a mixture thereof.

The surfactant can be or include one or more nonionic surfactants, one or more anionic surfactants, one or more cationic surfactants, or any mixture thereof. Illustrative nonionic surfactants can include, but are not limited to, polyethylene glycol (PEG) including PLURACOL® PEG-4, PEG-6, PRG-8, PEG-12, PEG-75, and PEG-150, all commercially available from BASF, Co., polyoxyethylene glycol alkyl ethers, octaethylene glycol monododecyl ether, pentaethylene glycol monododecyl ether, polyoxypropylene glycol alkyl ethers, polyoxyethylene glycol octylphenol ethers (TRITON® X-100), polyoxyethylene glycol alkylphenol ethers (nonoxynol-9), or any mixture thereof. Anionic surfactants can have anionic functional groups at the chain head, such as carboxylates, phosphate, sulfate, sulfonate, and other anionic groups. Illustrative anionic surfactants can include, but are not limited to, one or more lignosulfonates, alkyl sulfates (e.g., lauryl sulfates), alkyl-ether sulfates, or any mixture thereof. Illustrative lignosulfonates can include, but are not limited to, sodium lignosulfonate, lithium lignosulfonate, potassium lignosulfonate, calcium lignosulfonate, magnesium lignosulfonate, ammonium lignosulfonate, alkylammonium lignosulfonate, salts thereof, complexes thereof, or any mixture thereof. Illustrative cationic surfactants can include, but are not limited to, one or more quaternary ammonium cations, such as, alkyltrimethylammonium salts: cetyl trimethylammonium bromide (CTAB), cetyl trimethylammonium chloride (CTAC), cetylpyridinium chloride (CPC), benzalkonium chloride (BAC), benzethonium chloride (BZT), 5-Bromo-5-nitro-1,3-dioxane, dimethyldioctadecylammonium chloride, cetrimonium bromide, dioctadecyldimethylammonium bromide (DODAB), salts thereof, complexes thereof, or any mixture thereof.

Illustrative alkaline compounds can include, but are not limited to, one or more hydroxides, one or more carbonates, ammonia, one or more amines, or any mixture thereof. Illustrative hydroxides can include, but are not limited to, sodium hydroxide, potassium hydroxide, ammonium hydroxide (e.g., aqueous ammonia), lithium hydroxide, cesium hydroxide, or any mixture thereof. Illustrative carbonates can include, but are not limited to, sodium carbonate, sodium bicarbonate, potassium carbonate, lithium carbonate, ammonium carbonate, or any mixture thereof. Illustrative amines can include, but are not limited to, trimethylamine, triethylamine, triethanolamine, diisopropylethylamine (Hunig's base), pyridine, 4-dimethylaminopyridine (DMAP), 1,4-diazabicyclo[2.2.2]octane (DABCO), or any mixture thereof. The alkaline compound can be used to adjust the pH of the adhesive. As noted above, the alkaline compound can be the same compound or different if the aqueous aldehyde-based resin includes the alkaline compound.

The adhesive can include a kraft lignin mixture that can be or include the kraft lignin, the surfactant, and water. For example, the kraft lignin mixture can be or include about 0.5 wt %, about 1 wt %, about 1.5 wt %, about 2 at %, about 2.5 wt %, or about 3 wt % to about 5 wt %, about 6 wt %, about 7 wt %, about 8 wt %, about 9 wt %, or about 10 wt % of the surfactant (e.g., lignosulfonate), based on a combined weight of the kraft lignin and the surfactant. In another example, the kraft lignin mixture can be or include about 90, about 91 wt %, about 92 wt %, bout 93 wt %, about 94 wt %, or about 95 wt % to about 96 wt %, about 97 wt %, about 98 wt %, about 99 wt %, or about 99.5 wt % of the kraft lignin, based on the combined weight of the kraft lignin and the surfactant. In another example, the kraft lignin mixture can be or include about 10 wt % to about 50 wt % of the kraft lignin and about 0.1 wt % to about 5 wt % of the surfactant, based on the combined weight of the kraft lignin, the surfactant, and the water.

The kraft lignin mixture can also include an alkaline compound. For example, the kraft lignin mixture can be or include the kraft lignin, the surfactant, the alkaline compound, and water. For example, the kraft lignin mixture can include about 0.5 wt %, about 1 wt %, about 1.5 wt %, about 2 at %, about 2.5 wt %, or about 3 wt % to about 5 wt %, about 6 wt %, about 7 wt %, about 8 wt %, about 9 wt %, or about 10 wt % of the surfactant (e.g., lignosulfonate), based on a combined weight of the kraft lignin, the surfactant, and the alkaline compound. In another example, the kraft lignin mixture can include about 90, about 91 wt %, about 92 wt %, bout 93 wt %, about 94 wt %, or about 95 wt % to about 96 wt %, about 97 wt %, about 98 wt %, about 99 wt %, or about 99.5 wt % of the kraft lignin, based on the combined weight of the kraft lignin, the surfactant, and the alkaline compound. In another example, the kraft lignin mixture can include about 1 wt %, about 2 wt %, about 3 wt %, about 4 wt %, about 5 wt %, about 6 wt %, about 7 wt %, or about 8 wt % to about 10 wt %, about 11 wt %, about 12 wt %, about 13 wt %, about 14 wt %, or about 15 wt % of the alkaline compound, based on the combined weight of the kraft lignin, the surfactant, and the alkaline compound. In some example, the kraft lignin mixture can include about 70 wt % to about 98 wt % of the kraft lignin, about 1 wt % to about 12 wt % of the surfactant, and about 2 wt % to about 25 wt % of the alkaline compound, based on the combined weight of the kraft lignin, the surfactant, and the alkaline compound. In other examples, the kraft lignin mixture can be or include about 10 wt % to about 50 wt % of the kraft lignin, about 0.1 wt % to about 5 wt % of the surfactant, and about 0.5 wt % to about 10 wt % of the alkaline compound, based on the combined weight of the kraft lignin, the surfactant, the alkaline compound, and the water.

The adhesive can be or include the aldehyde-based resin, about 1 wt % to about 15 wt % of the kraft lignin, about 0.005 wt % to about 1 wt % of the surfactant, about 1 wt % to about 10 wt % of the extender, and about 45 wt % to about 65 wt % of water, where all weight percent values are based on the solids weight of the aldehyde-based resin. The adhesive can also include the alkaline compound, the filler, and/or the salt. For example, the adhesive can be or include about 20 wt % to about 30 wt % of the aldehyde-based resin, about 1 wt % to about 10 wt % of the kraft lignin, about 0.05 wt % to about 1 wt % of the surfactant, about 0.5 wt % to about 5 wt % of the alkaline compound, about 1 wt % to about 10 wt % of the extender, about 1 wt % to about 10 wt % of the filler, about 0.1 wt % to about 5 wt % of the salt, and about 50 wt % to about 65 wt % of water, where all weight percent values are based on the combined weight of the aldehyde-based resin, the kraft lignin, the surfactant, the alkaline compound, the extender, the filler, the salt, and the water.

Illustrative fillers can include, but are not limited to, nut shell media, corn media or corn cob media, furfural residues, or any mixture thereof. The nut shell media can be or include whole, broken, chopped, crushed, milled, and/or ground shells from one or more nuts and/or seeds. Illustrative nut shell media can include, but is not limited to, almond, walnut, pecan, chestnut, hickory, cashew, peanut, macadamia, or any mixture thereof. The corn media can be or include broken, chopped, crushed, or ground corn cobs, corn stalks, or other corn derived products, or any mixture thereof. Corn media can also include furfural residue from corn cobs, corn stalks, or other corn derived products. An illustrative corn derived product can include, but is not limited to, a cellulose byproduct derived from the manufacture of furfural, such as WILVACO-FIL® corn cob residue, commercially available from Willamette Valley Company, Inc., Eugene, Oreg. Furfural residues, including floral and furfural-derived compounds, can also come from oat, wheat, wheat bran, barely, wood particles, sawdust, and/or other plant-based products. Illustrative seed shells (including fruit pits), can include, but are not limited to, the seed shells or pits of fruit, e.g., plum, peach, cherry, apricot, olive, mango, olive, jackfruit, guava, custard apples, pomegranates, pumpkins, watermelon, ground or crushed seed shells of other plants such as maize (e.g., corn cobs or corn kernels), wheat, rice, jowar, sunflowers, or the like, or any mixture thereof. Other examples of suitable fillers include, but are not limited to, wheat shell, corn husk, peanut shell, or any combination thereof.

Illustrative extenders can include, but are not limited to, one or more flours, one or more polysaccharides, one or more starches, one or more polysaccharide starches, or any mixture thereof. Flours can be ground or milled to a variety of different granular sizes, such as fine, ultra-fine, or very ultra-fine granular sizes. Illustrative flours can include, but are not limited to, wheat flour, corn flour, soy flour, oat flour, other grain flours, nut or seed flour (e.g., almond, walnut, pecan, cashew, or peanut), brands thereof, starches thereof, or any mixture thereof. In some examples, the extender can be or include corn flours or corn starches, such as NCS-83, NCS-74, and 4501 flours, commercially available from Didion Milling Company, Inc., Sun Prairie, Wis. In other examples, the extender can be or include wheat flours, wheat starches, and/or wheat derived protein-starch composition, such as GLU-X® extender, commercially available from Siemer Milling Company, Teutopolis, Ill. Illustrative polysaccharides can include, but are not limited to, starch, cellulose, gums, such as guar and xanthan, alginates, pectin, gellan, or any mixture thereof. Suitable polysaccharide starches can include, for example maize or corn, native corn starch (NCS), waxy maize, high amylose maize, potato, tapioca, wheat starch, or any mixture thereof. Other starches, such as genetically engineered starches, can include high amylose potato starches, potato amylopectin starches, or any mixture thereof.

The salt can have one or more cations and one or more anions. Illustrative cations can include, but are not limited to, sodium, potassium, lithium, cesium, calcium, magnesium, barium, copper, cobalt, zinc, manganese, aluminum, ammonium, alkylammonium, complexes thereof, hydrates thereof, or any mixture thereof. Illustrative anions can include, but are not limited to, carbonates, bicarbonates, halides, e.g., chlorides and/or bromides, nitrates, nitrites, silicates, acetates, citrates, formates, sulfates, phosphates, or any mixture thereof. In some specific examples, the salt can be or include one or more carbonates, such as, sodium carbonate, e.g., soda ash, potassium carbonate, calcium carbonate, lithium carbonate, ammonium carbonate, or any mixture thereof.

In one or more examples, the adhesive can be made by combining one or more kraft lignins, one or more surfactants, e.g., lignosulfonates, and water to produce the kraft lignin mixture. The kraft lignin mixture can have a pH value of about 10 or greater. For example, the kraft lignin mixture can have a pH of about 10, about 10.5, about 11, about 11.5, about 12, about 12.5, or about 13. In another example, the kraft lignin mixture can have a pH of about 10 to about 13, about 10.5 to about 13, about 11 to about 13, about 10 to about 12.5, about 10 to about 12, about 10 to about 11.5, about 11 to about 13, or about 11 to about 12. In another example, the kraft lignin mixture can have a pH of about 10, about 10.5, about 11, about 11.5, about 12, about 12.5, or about 13 at a temperature of about 25° C., when the kraft lignin mixture has a solids concentration of about 25 wt %. In another example, the kraft lignin mixture can have a pH of at least 9, at least 9.3, at least 9.5, at least 9.7, at least 10, at least 10.3, at least 10.5, at least 10.7, or at least 11 to about 11.3, about 11.5, about 11.7, about 12, or about 12.5 at a temperature of about 25° C., when the kraft lignin mixture has a solids concentration of about 25 wt %.

In one example, the aldehyde-based resin, the extender, and the kraft lignin mixture can be combined to produce the adhesive, where the adhesive can have a viscosity of about 1,500 cP to about 2,500 cP, at a temperature of about 25° C. In another example, the kraft lignin, the surfactant, the alkaline compound, and water can be combined to form or produce an aqueous mixture having a pH of about 10 to about 12.5. The aqueous mixture can be maintained at a temperature of about 60° C. to about 120° C. for at least 1 hour. For example, the aqueous mixture can be maintained at a temperature of about 60° C. to about 120° C. for about 1 hour to about 6 hours. The aldehyde based resin and, if desired, water can be combined with the aqueous mixture to produce the adhesive.

In some examples, the adhesive can have a secondary viscosity of greater than the initial viscosity to less than 150% of the initial viscosity, where the secondary viscosity is measured 24 hours from the time of producing of the adhesive. In other examples, the secondary viscosity can be about 1,600 cP to about 3,000 cP, at a temperature of about 25° C. In other examples, the secondary viscosity can be about 1,600 cP to about 2,800 cP, at a temperature of about 25° C. In other examples, the secondary viscosity can be about 1,600 cP to about 3,500 cP, at a temperature of about 25° C. In other examples, the secondary viscosity can be about 1,800 cP to about 3,000 cP, at a temperature of about 25° C. In other examples, the adhesive can have a secondary viscosity of about 1,600 cP, about 1,700 cP, or about 1,800 cP to about 2,800 cP, about 3,000 cP, or about 3,500 cP, at a solids content of about 42 wt % to about 46 wt % and at a temperature of about 25° C. The adhesive can be maintained at a temperature of about 20° C. to about 30° C., such as about 25° C., from the time the adhesive is produced to when the secondary viscosity is measured.

In some examples, the adhesive can be made by combining the aldehyde-based resin, the extender, the kraft lignin mixture, the alkaline compound, and water to form or produce an aqueous mixture and agitating the aqueous mixture to form or produce the adhesive. The method can also include combining the filler and the salt with the aldehyde-based resin, the extender, the kraft lignin mixture, the alkaline compound, and water to form or produce the aqueous mixture. The filler can be or include corn cob media, nut shell media, or a mixture thereof, and the salt can be or include sodium carbonate, potassium carbonate, calcium carbonate, lithium carbonate, ammonium carbonate, or any mixture thereof.

In one or more examples, the method for making a composite product can include combining the kraft lignin, the surfactant, and water to produce the kraft lignin mixture that has a pH of about 10 or greater, and combining the aldehyde-based resin, the extender, and the kraft lignin mixture to produce the adhesive, where the adhesive can have an initial viscosity of about 1,500 cP to about 2,500 cP, at a temperature of about 25° C. For example, the method for making a composite product can include combining the kraft lignin, the surfactant, and water to produce the kraft lignin mixture that has a pH of about 10 or greater, and combining the aldehyde-based resin and the kraft lignin mixture to produce the adhesive, where the adhesive can have an initial viscosity of about 1,500 cP to about 2,500 cP, at a solids content of about 42 wt % to about 46 wt % and at a temperature of about 25° C. The method can also include combining or otherwise contacting a plurality of lignocellulose substrates and the adhesive to produce a resinated furnish. The adhesive or at least the aldehyde-based resin in the adhesive can be at least partially cured, e.g., by heating the resinated furnish, to produce the composite product. The resinated furnish can be or include the aldehyde based resin, the kraft lignin, the surfactant, the alkaline compound, and water. The resinated furnish can also include, but is not limited to, the extender, the filler, the salt, or any mixture thereof.

In one or more examples, one or more additives can be combined with the adhesive and/or any one or more components of the adhesive, to produce the composite product. Illustrative additives can include, but are not limited to, waxes and/or other hydrophobic additives, release agents, dyes, fire retardants, formaldehyde scavengers, biocides, or any mixture thereof. In some examples, the mixtures, compositions, and products, including, but not limited to, the kraft lignin mixture, the adhesive, the composite product, can be produced by a process for homogenizing, agitating, mixing, blending, or otherwise combining process, such as with homogenization, ultrasonication, colloid milling, microfluidic mixing as a method of homogenization, or other similar processes.

Illustrative composite products can include, but are not limited to, plywood (e.g., hardwood plywood and/or softwood plywood), oriented strand board (“OSB”), laminated veneer lumber (“LVL”), laminated veneer boards (“LVB”), engineered wood flooring, particleboard, fiberboard (e.g., medium density fiberboard (“MDF”) and/or high density fiberboard (“HDF”)), or other wood and non-wood products.

In some examples, the method can also include applying the adhesive between two or more wood veneers or wood sheets to produce the composite product (e.g., plywood, OSB, LVL, LVB, or engineered wood flooring). The plurality of lignocellulose substrates can be or include wood veneers or wood sheets and the adhesive can be disposed between wood veneers or wood sheets. In other examples, the method can also include forming a lignocellulose adhesive mixture or “resinated furnish” by combining the plurality of lignocellulose substrates and the adhesive, and heating the adhesive to produce the composite product (e.g., particleboard, MDF, or HDF).

In some examples, the method can further include maintaining the adhesive at a temperature of less than 60° C. for at least 10 min before heating the mixture. For example, the adhesive can be maintained at the temperature of less than 60° C. for at least 1 hr to about 18 hr. In some examples, subsequent to maintaining the adhesive at a designated temperature, the adhesive can be heated to a temperature of at least 60° C. to about 300° C. for about 0.1 min to about 30 min to produce the composite product. In another example, the method can further include pressing the adhesive when the adhesive is heated to produce the composite product. The adhesive can be pressed to a pressure of about 0.5 MPa to about 15 MPa.

The adhesive can include one or more lignins, including kraft lignins and/or other lignins. Lignin is a polymeric substance that can include substituted aromatics found in plant and vegetable matter associated with cellulose and other plant constituents. Illustrative plant and vegetable matter can include, but is not limited to, straw, hemp, sisal, cotton stalk, wheat, bamboo, sabai grass, rice straw, banana leaves, paper mulberry, e.g., bast fiber, abaca leaves, pineapple leaves, esparto grass leaves, jute fibers from the genus Hesperaloe in the family Agavaceae, salt water reeds, palm fronds, flax, ground nut shells, hardwoods, softwoods, recycled fiberboards such as high density fiberboard, medium density fiberboard, low density fiberboard, oriented strand board, particleboard, or any mixture thereof. For example, the plant matter can be or include wood, for example hardwoods, softwoods, or a combination thereof. Illustrative types of wood can include, but are not limited to, alder, ash, aspen, basswood, beech, birch, cedar, cherry, cottonwood, cypress, elm, fir, gum, hackberry, hickory, maple, oak, pecan, pine, poplar, redwood, sassafras, spruce, sycamore, walnut, and willow.

The lignin can be extracted, separated, or otherwise recovered from the wood, plant, and/or vegetable matter using any of a number of well-established processes. For example, in the pulp and paper industry, lignin-containing materials such as wood, straw, corn stalks, bagasse, and other vegetable and plant tissues can be processed to recover the cellulose or pulp via the known kraft process, sulfate process, or sulfite process. The residual pulping liquors that include the lignin as a byproduct can be a source of lignin. The chemical structure of lignin can vary and the variation can depend, at least in part, on the particular plant from which the lignin is recovered from, location the plant was grown, and/or on the particular method used in recovery or isolation of the lignin from the plant and/or vegetable matter. Lignin can include active groups, such as active hydrogens and/or phenolic hydroxyl groups through which crosslinking or bridging can be effected.

One process for recovering lignin can include the process commonly referred to as the organosolv process. The organosolv process uses an organic solvent to solubilize lignin and hemicelluloses. The organosolv process can include contacting lignocellulose material, e.g., wood chips or particles, with an aqueous organic solvent at a temperature of about 130° C., about 140° C., or about 150° C. to about 200° C., about 220° C., or about 230° C. The lignin can break down by hydrolytic cleavage of alpha aryl-ether links into fragments that can be solubilized in the solvent system. Illustrative solvents can include, but are not limited to, acetone, methanol, ethanol, butanol, ethylene glycol, formic acid, acetic acid, or any mixture thereof. The aqueous organic solvent can have a concentration of the solvent in water of about 30 wt %, about 40 wt % or about 50 wt % to about 70 wt %, about 80 wt %, or about 90 wt %.

Since the lignin separated from the plant can be chemically altered from that found in the plant, the term “lignin,” can also refer to lignin products obtained upon separation from the cellulose or recovered from the plant matter. For example, in a sulfite pulping process, the lignocellulose material can be digested with a bisulfite or sulfite resulting in the at least partial sulfonation of the lignin. As such, the lignin can optionally be subjected to further cleavage and/or other modifications such as alkaline treatment or reaction with other constituents to decrease the sulfonate or sulfur content and/or increase the active groups.

In other methods of recovery or separation of lignin from wood, plant, or vegetable material, the lignin may not be sulfonated, but could be chemically altered somewhat in some other manner. For example, in residual pulping liquors obtained in sulfate or other alkaline pulping processes, the lignin can be present as an alkali metal salt dissolved in the alkaline, aqueous liquor and can generally include a sufficient phenolic hydroxyl content to require no further modification. However, the alkali or kraft lignin can be further reacted with other constituents to further increase the active groups. “Hydrolysis lignin” that can be recovered from the hydrolysis of lignocellulose materials in the manufacture of sugar, for example, can also be altered somewhat from that found in the plant. As such hydrolysis lignin can be further modified to solubilize the lignin as well as to increase the phenolic hydroxyl content. Also, the lignin products such as residual pulping liquor may be subjected to various treatments such as, for example, acid, alkaline or heat treatments or reacted with the other chemicals which may further alter somewhat the lignin constituents.

The residual pulping liquors or the lignin products produced in the separation or recovery of lignin from the plant matter can include lignin of various weight average molecular weights (MW) of about 300 to about 100,000 or greater. For example, the lignin can have a MW of about 500, about 1,000, about 5,000, about 10,000, about 15,000, or about 20,000 to about 30,000, about 45,000, about 55,000, about 70,000, about 80,000, about 85,000, about 90,000, or about 95,000. In another example, the lignin can have a MW of about 300, about 500, about 800, about 900, about 1,000, or about 1,100 to about 1,300, about 1,500, about 1,900, about 2,300, about 2,500, about 2,700, about 3,000, about 3,300, about 3,500, about 3,700, about 4,000, about 4,300, about 4,500, about 4,700, or about 5,000. In another example, the lignin can have a MW of about 500 to about 30,000, about 1,000 to about 15,000, about 800 to about 6,000, about 2,000 to about 12,000, about 400 to about 10,000, or about 600 to about 8,000. In another example, the MW of the lignin can be about 600 to about 4,500, about 350 to about 1,100, about 750 to about 2,500, about 950 to about 3,100, about 1,500 to about 3,400, or about 1,800 to about 4,200. The number average and weight average MW can be measured using gel permeation chromatography (“GPC”), also known as size exclusion chromatography (“SEC”). This technique utilizes an instrument containing columns packed with porous beads, an elution solvent, and detector in order to separate polymer molecules of different sizes, and is well known to those skilled in the art.

In one or more examples, the lignin can be insoluble in water having a pH of about 7 and at a temperature of about 25° C. In one or more examples, the lignin can be substantially insoluble in water having a pH of about 7 and at a temperature of about 25° C. For example, a maximum amount of the lignin capable of dissolving in water at a temperature of about 25° C. and having a pH of about 7 can be 5 wt %, 4.5 wt %, 4 wt %, 3.5 wt %, 3 wt %, 2.5 wt %, 2 wt %, 1.5 wt %, 1 .3 wt %, 1 wt %, 0.9 wt %, 0.8 wt %, 0.7 wt %, 0.6 wt %, 0.5 wt %, 0.4 wt %, 0.3 wt %, 0.2 wt %, or 0.1 wt %, or less. In another example, the lignin can have a solubility in water having a pH of about 7 and at a temperature of about 25° C. of less than 5 wt %, less than 4 wt %, less than 3 wt %, 2.5 wt %, 2 wt %, 1.5 wt %, 1.3 wt %, 1 wt %, 0.9 wt %, 0.8 wt %, 0.7 wt %, 0.6 wt %, 0.5 wt %, 0.4 wt %, 0.3 wt %, 0.2 wt %, or 0.1 wt %, or less. In at least one example, a kraft lignin can be insoluble or substantially insoluble in water having a pH of about 7 and at a temperature of about 25° C.

Depending on the particular lignin, the amount of ash contained in the lignin can widely vary. For example, the lignin can include about 1 wt %, about 1.5 wt %, about 2 wt %, about 2.5 wt %, or about 3 wt % to about 4 wt %, about 5 wt %, about 6 wt %, about 7 wt %, about 8 wt %, about 9 wt %, about 10 wt %, or more of ash. In another example, the lignin can be or include kraft lignin and the kraft lignin can include less than 3 wt %, less than 2.7 wt %, less than 2.5 wt %, less than 2.3 wt %, less than 2 wt %, less than 1.7 wt %, less than 1.5 wt %, less than 1.3 wt %, less than 1 wt %, less than 0.9 wt %, less than 0.8 wt %, less than 0.7 wt % less than 0.6 wt %, less than 0.5 wt %, less than 0.4 wt %, less than 0.3 wt %, less than 0.2 wt %, less than 0.1 wt %, less than 0.07 wt %, less than 0.05 wt %, or less than 0.02 wt % of ash, based on a dry weight of the kraft lignin. The ash content of the lignin can be measured according to ASTM D2584-11: Standard Test Method for Ignition Loss of Cured Reinforced Resins.

Depending on the particular lignin, the amount of sulfur contained in the lignin can widely vary. For example, the lignin an include about 1 wt %, about 1.5 wt %, about 2 wt %, about 2.5 wt %, or about 3 wt % to about 4 wt %, about 5 wt %, about 6 wt %, about 7 wt %, about 8 wt %, about 9 wt %, about 10 wt %, or more of sulfur. In another example, the lignin can contain less than 5 wt % of sulfur, less than 4.5 wt % of sulfur, less than 4 wt % of sulfur, less than 3.5 wt % of sulfur, less than 3 wt % of sulfur, less than 2.7 wt % of sulfur, less than 2.5 wt % of sulfur, less than 2.3 wt % of sulfur, less than 2 wt % of sulfur, less than 1.7 wt % of sulfur, or less than 1.5 wt % of sulfur. In another example, the lignin can include about 6 wt % or more, about 6.5 wt % or more, about 7 wt % or more, or about 7.5 wt % or more to about 8 wt %, about 9 wt %, or about 10 wt % of sulfur. In another example, the lignin can be kraft lignin and the kraft lignin can contain less than 5 wt % of sulfur, less than 4.5 wt % of sulfur, less than 4 wt % of sulfur, less than 3.5 wt % of sulfur, less than 3 wt % of sulfur, less than 2.7 wt % of sulfur, less than 2.5 wt % of sulfur, less than 2.3 wt % of sulfur, less than 2 wt % of sulfur, less than 1.7 wt % of sulfur, or less than 1.5 wt % of sulfur. In another example, the surfactant can be or include a lignosulfonate and the lignosulfonate can include about 6 wt % or more, about 6.5 wt % or more, about 7 wt % or more, or about 7.5 wt % or more to about 8 wt %, about 9 wt %, or about 10 wt % of sulfur.

The sulfur content of the lignin can be measured or calculated using elemental analysis techniques. For example, the sulfur content of the lignin can be indirectly determined or estimated using CHN analysis, which can be accomplished by combustion analysis. More particularly, a sample of the lignin can be burned in an excess of oxygen, and various traps can collect the combustion products, such as carbon dioxide, water, and nitric oxide. The masses of these combustion products can be used to calculate the composition of the unknown sample.

In one or more examples, a ratio of aromatic carbon atoms plus alkenic carbon atoms to aliphatic carbon atoms (aromatic carbon atoms+alkenic carbon atoms: aliphatic carbon atoms) in the lignin can be about 1:1, about 1.3:1, about 1.5:1, about 1.7:1, about 2:1, about 2.3:1, about 2.5:1, or about 2.7:1 to about 3.5:1, about 3.7:1, about 4:1, about 4.3:1, about 4.5:1, about 4.7:1, about 5:1, about 5.3:1, about 5.5:1, about 5.7:1, or about 6:1, based on quantitative analysis of ¹³C NMR spectra of the lignin. In one example, the lignin can have a ratio of aromatic carbon atoms plus alkenic carbon atoms to aliphatic carbon atoms of at least 2.5:1, at least 2.7:1, at least 3:1, at least 3.3:1, at least 3.5:1, at least 3.7:1, at least 4:1, at least 4.3:1, at least 4.5:1, at least 4.7:1, or at least 5:1 to about 5.3:1, about 5.5:1, about 5.7:1, or about 6:1, based on quantitative analysis of ¹³C NMR spectra of the lignin. In another example, the lignin can have a ratio of aromatic carbon atoms plus alkenic carbon atoms to aliphatic carbon atoms of about 1:1 to about 2:1, about 1.1:1 to about 1.9:1, about 1.2:1 to about 1.8:1, about 1.3:1 to about 1.7:1, about 1.4:1 to about 1.6:1, based on quantitative analysis of ¹³C NMR spectra of the lignin. In another example, the lignin can have a ratio of aromatic carbon atoms plus alkenic carbon atoms to aliphatic carbon atoms of about 1.5:1, about 2:1, about 2.5:1, about 3:1, about 3.5:1, about 4:1, about 4.5:1, or about 5:1, based on quantitative analysis of ¹³C NMR spectra of the lignin. In another example, the lignin can be kraft lignin and the kraft lignin can have a ratio of aromatic carbon atoms plus alkenic carbon atoms to aliphatic carbon atoms of about at least 2.5:1, at least 2.7:1, at least 3:1, at least 3.3:1, at least 3.5:1, at least 3.7:1, at least 4:1, at least 4.3:1, at least 4.5:1, at least 4.7:1, or at least 5:1 to about 5.3:1, about 5.5:1, about 5.7:1, or about 6:1, based on quantitative analysis of ¹³C NMR spectra of the kraft lignin. In another example, the surfactant can be a lignosulfonate and the lignosulfonate can have a ratio of aromatic carbon atoms plus alkenic carbon atoms to aliphatic carbon atoms of about 1:1 to about 2:1, about 1.1:1 to about 1.9:1, about 1.2:1 to about 1.8:1, about 1.3:1 to about 1.7:1, about 1.4:1 to about 1.6:1, based on quantitative analysis of ¹³C NMR spectra of the lignosulfonate.

The liquors from which the lignin can be recovered can also include one or more other constituents in addition to the lignin. For example, in the sulfite pulping process, the spent sulfite liquor can include lignosulfonates that can be present as salts of cations, such as magnesium, calcium, ammonium, sodium, potassium, and/or other cations. The spent sulfite liquor solids can include about 40 wt % to about 65 wt % lignosulfonates with the remainder being carbohydrates and other organic and inorganic constituents dissolved in the liquor. Lignin products produced by other pulping processes can also include other materials such as carbohydrates, degradation products of carbohydrates, and resinous materials which are separated from the cellulosic materials with the lignin. It should be noted that it is not necessary to separate the lignin from the other constituents that can be present.

Suitable processes for isolating or otherwise separating lignin or lignin containing products form wood, plant, vegetable, or other lignin containing matter can include those discussed and described in U.S. Pat. Nos.: 1,856,567; 2,525,433; 2,680,113; 2,690,973; 3,094,515; 3,158,520; 3,503,762; 3,585,104; 3,726,850; 3,769,272; 3,841,887; 4,100,016; 4,131,564; 4,184,845; 4,308,203; 4,355,996; 4,470,876; 4,740,591; 4,764,596; 8,172,981 and 8,486,224; U.S. Patent Application Publication No.: 2011/0294991; and WO Publication Nos. WO1992/018557A1, WO1993/021260A2; WO1994/024192A1; WO2005/062800A2; WO2006/031 175 A1; and WO2011/150508. Commercially available lignin can include, but is not limited to, lignosulfonates available from Tembec, Inc., Montreal, Quebec, Canada.

In one or more examples, the lignin can be or include kraft lignin, alkali lignin, or a mixture thereof. Kraft lignin and alkali lignin are known materials of commerce. The CAS numbers for kraft lignin and alkali lignin are 8068-05-1 and 37203-80-8, respectively. The lignin, e.g., kraft lignin, can be a solid, e.g., a solid powder. The lignin, e.g., kraft lignin, can be in the form of a liquid solution, mixture, and/or dispersion.

The resinated furnish can be heated to produce a lignocellulose containing composite product or “composite product.” For example, the mixture can be heated to a temperature of about 60° C., about 90° C., about 120° C., about 150° C., or about 160° C. to about 170° C., about 200° C., about 230° C., about 260° C., or about 300° C. to produce the composite product. In another example, the mixture can be heated to a temperature of at least 60° C., at least 70° C., at least 80° C., at least 90° C., at least 100° C., at least 110° C., at least 120° C., at least 130° C., or at least 140° C. to about 150° C., about 155° C., about 160° C., about 165° C., about 170° C., about 180° C., about 200° C., about 225° C., about 250° C., about 275° C., or about 300° C. In another example, the mixture can be heated to a temperature of about 140° C. to about 200° C., about 155° C. to about 175° C., about 160° C. to about 210° C., about 160° C. to about 175° C., or about 145° C. to about 225° C.

In one or more examples, the resinated furnish can be heated in air. In another example, the resinated furnish can be heated in an inert atmosphere or substantially an inert atmosphere such as nitrogen. If the resinated furnish is heated in a substantially inert atmosphere, the amount of oxygen can be less than 5 mol %, less than 3 mol %, less than 1 mol %, less than 0.5 mol %, or less than 0.1 mol % oxygen relative to the balance of gases in the inert atmosphere. Suitable inert gases can include, but are not limited to, nitrogen, argon, helium, or a mixture thereof.

Heating the adhesive and/or the resinated furnish can cause or promote the at least partial curing of the adhesive to produce the composite product. As used herein, the terms “curing,” “cured,” “at least partially curing,” “at least partially cured,” and similar terms are intended to refer to the structural and/or morphological change that occurs in the mixture, such as by covalent chemical reaction (crosslinking), ionic interaction or clustering, phase transformation or inversion, and/or hydrogen bonding when the is subjected to conditions sufficient, e.g., sufficiently heated, to cause the properties of a flexible, porous substrate, such as a nonwoven mat or blanket of lignocellulose substrates and/or a rigid or semi-rigid substrate, such as a wood or other lignocellulose containing board or sheet, to which an effective amount of the adhesive has been applied, to be altered.

Composite products in the shape or form of a panel, sheet, board, or the like can be in the form of a rectangular prism that includes six outer surfaces, e.g., three pairs of oppositely facing surfaces. The first pair of oppositely facing surfaces of the composite product can include a first or “top” surface and an opposing second or “bottom” surface. The second and third pairs of oppositely facing surfaces of the composite product can be referred to as the “side surfaces” that have a surface area less than the surface area of the first and second surfaces. As such, composite products in the shape or form of a panel, sheet, board, or the like can have an average thickness, where the average thickness is the length or distance between the first and second surfaces.

If the composite product is in the form of a panel, sheet, board, or the like, the amount or length of time the resinated furnish can be heated can be about 5 seconds per millimeter (s/mm), about 10 s/mm, about 12 s/mm, or about 15 s/mm to about 17 s/mm, about 19 s/mm, about 21 s/mm, about 23 s/mm, about 25 s/mm, about 27 s/mm, about 30 s/mm, about 35 s/mm, about 40 s/mm, about 50 s/mm, or about 60 s/mm, where the length refers to the average thickness of the composite product. For example, the resinated furnish can be heated for a time of about 5 s/mm to about 55 s/mm, about 10 s/mm to about 45 s/mm, about 15 s/mm to about 40 s/mm, about 5 s/mm to about 25 s/mm, about 7 s/mm to about 27 s/mm, about 9 s/mm to about 24 s/mm, about 11 s/mm to about 22 s/mm, about 8 s/mm to about 20 s/mm, about 14 s/mm to about 18 s/mm, about 6 s/mm to about 14 s/mm, about 10 s/mm to about 18 s/mm, or about 10 s/mm to about 16 s/mm, where the length refers to the average thickness of the composite product. In another example, the resinated furnish can be heated for a time less than 120 s/mm, less than 110 s/mm, less than 100 s/mm, less than 90 s/mm, less than 80 s/mm, less than 70 s/mm, less than 60 s/mm, less than 50 s/mm, less than 40 s/mm, less than 30 s/mm, less than 25 s/mm, less than 22 s/mm, less than 20 s/mm, less than 18 s/mm, less than 17 s/mm, less than 16 s/mm, less than 15 s/mm, less than 14 s/mm, less than 13 s/mm, or less than 12 s/mm, where the length refers to the average thickness of the composite product. In one specific example, a composite product in the form of a panel, sheet, board, or the like and having an average thickness of about 15 mm and subjected to a total heating time of about 4 minutes would correspond to heating the mixture for about 16 s/mm. In at least one specific example, the resinated furnish can be heated to a temperature of about 160° C. to about 170° C. for a time of about 10 s/mm to about 30 s/mm, about 13 s/mm to about 19 s/mm, about 15 s/mm to about 40 s/mm, or about 8 s/mm to about 50 s/mm.

Pressure can optionally be applied to the resinated furnish before, during, and/or after the resinated furnish is heated to produce the composite product. For example, if the desired composite product shape or structure is a panel, sheet, board, or the like, an amount of the mixture sufficient to produce a composite product of the desired size, can be transported, directed, placed, introduced, disposed, or otherwise located within a press capable of pressing the mixture before the mixture is heated and/or when the mixture is heated. The press can be an open press or a closed press. In at least one specific example, an open press can be used to press the mixture when the mixture is heated, e.g., to a temperature of about 100° C. to about 250° C. In another example, the mixture can be extruded through a die (extrusion process) and heated to produce the composite product. The mixture can be pressed under a pressure of about 0.5 MPa, about 1 MPa, about 3 MPa, or about 5 MPa to about 7 MPa, about 9 MPa, or about 11 MPa.

Illustrative open presses can be as discussed and described in U.S. Pat. Nos.: 4,017,248; 5,337,655; 5,611,269; 5,950,532; 6,098,532; and 6,782,810. Suitable, commercially available, open presses can include, but are not limited to, the CONTIROLL® press available from Siempelkamp and the CPS press available from Dieffenbacher.

The lignocellulose substrates can be or include any one or more of the plant and vegetable materials discussed and described above with reference to the source for the lignins. As used herein, the term “lignocellulose” refers to a material that includes lignin and cellulose, hemicellulose, or a combination of cellulose and hemicelluloses. The starting material, from which the lignocellulose substrates can be or can be derived from, can be shaped, reduced, or otherwise formed to the appropriate dimensions by various processes such as hogging, grinding, hammer milling, tearing, shredding, and/or flaking. Other processes for producing the substrates can include skiving, cutting, slicing, and/or sawing. Suitable forms of the lignocellulose substrates can include, but are not limited to, chips, flakes, wafers, fibers, powder, shavings, sawdust or dust, veneer, strands, and/or the like. Accordingly, the term “substrate” when used in conjunction with “lignocellulose” refers to lignocellulose material or lignocellulose containing material having any desired shape such as chips, flakes, fibers, powder, shavings, sawdust or dust, veneer, strands, and/or the like. Other suitable lignocellulose substrates can include, but are not limited to, wood chips, wood fibers, wood flakes, wood strands, wood wafers, wood shavings, wood particles, wood veneer, or any mixture thereof.

The particular configuration of the substrates can be based, at least in part, on the desired product. For example, particulates such as chips, fibers, shavings, sawdust or dust, or the like can be used for producing particleboards, fiberboards, and the like. The substrates can have a length of about 0.05 mm, about 0.1 mm, about 0.2 mm to about 1 mm, about 5 mm, about 10 mm, about 20 mm, about 30 mm, about 40 mm, about 50 mm, or about 100 mm. In another example, veneers, e.g., layers or sheets of wood, can be used for producing plywood, laminated veneer lumber, and the like. The veneers can have a thickness of about 0.8 mm, about 0.9 mm, about 1 mm, about 1.1 mm or about 1.2 mm to about 3 mm, about 4 mm, about 5 mm, about 6 mm, about 7 mm, about 8 mm, about 9 mm, or about 10 mm.

The lignocellulose substrates can include liquid on, about, and/or within the substrates. For example, the lignocellulose substrates can have a liquid, e.g., moisture, content of about 1 wt %, about 2 wt %, about 3 wt %, about 4 wt %, or about 5 wt % to about 7 wt %, about 9 wt %, about 11 wt %, about 13 wt %, about 15 wt %, about 17 wt %, about 19 wt %, about 21 wt %, about 23 wt %, about 25 wt %, about 27 wt %, about 29 wt %, about 31 wt %, about 33 wt %, about 35 wt %, or about 37 wt % based on a dry weight of the lignocellulose substrate. In another example, the lignocellulose substrates can have a liquid, e.g., moisture, content of about 1 wt % to about 10 wt %, about 2 wt % to about 4 wt %, about 2 wt % to about 3 wt %, about 3 wt % to about 6 wt %, about 5 wt % to about 10 wt %, about 6 wt % to about 8 wt %, or about 4 wt % to about 9 wt %. The lignocellulose substrates can be fresh, e.g., not treated or dried, or dried and/or treated. For example, the lignocellulose substrates and/or the starting material from which the lignocellulose substrates were derived can be at least partially dried. In another example, the lignocellulose substrates can be washed and/or leached with an aqueous medium such as water.

The composite products can be made by a continuous or semi-continuous mixing process in which the lignocellulose substrates, the adhesive, and any other components, e.g., additives, can be introduced to a mixer at a first or introduction region, end, area, or other locations configured to receive the components and the adhesive or the lignocellulose substrates and adhesive mixture can be withdrawn from the mixer via one or more mixture recovery outlets. The mixer can be configured to contain a few hundred kilograms to several thousand kilograms. For example, in a single mixer about 500 kg/hr, about 5,000 kg/hr, about 10,000 kg/hr, or about 13,000 kg/hr to about 16,000 kg/hr, about 20,000 kg/hr, about 25,000 kg/hr, or about 30,000 kg/hr of the mixture can be recovered from the mixer. As the adhesive or the lignocellulose substrates and adhesive mixture exits the mixer, it can be deposited onto a conveyor belt and can be transported to one or more dryers, moistening systems, presses, and/or other processing equipment. For example, in at least one specific example, a particleboard product can be made mixing a first or “face” mixture and a second or “core” mixture in a first and second blend, respectively. The first mixer can produce about 13,600 kg/hr to about 15,900 kg/hr of a “face” mixture and the second mixer can produce about 18,100 kg/hr to about 20,400 kg/hr of a “core” mixture. The “face” and “core” mixtures can be used to produce a particleboard panel or sheet, where the “face” mixture makes up the outer layers of the particleboard and the “core” mixture makes up the inner or core layer of the particleboard.

Referring to particleboard in particular, particleboard made according to one or more embodiments discussed and described herein can meet or exceed the requirements for H-1, H-2, H-3, M-0, M-1, M-S, M-2, M-3i, LD-1, and/or LD-2 grade particleboard as described in the American National Standards Institute (ANSI) for particleboard, i.e., ANSI A208.1-2009 Particleboard, approved Feb. 2, 2009. Particleboard made according to one or more embodiments discussed and described herein can meet or exceed the requirements for PBU, D-2, D-3, and/or M-3 as defined by the ANSI for particleboard, i.e., ANSI A208.1-2009 Particleboard, approved Feb. 2, 2009. For example, Tables A and B set out certain requirements for the different grades of particleboard. Referring to oriented strand board (OSB) in particular, OSB made according to one or more embodiments discussed and described herein can meet or exceed the U.S. Department of Commerce Voluntary Performance Standard PS 2. Referring to plywood in particular, plywood made according to one or more embodiments discussed and described herein can meet or exceed the U.S. Department of Commerce Voluntary Product Standard PS 1-09 (May 2010) and/or PS 2-10 (June 2011).

Composite products such as particleboard, fiberboard, plywood, and oriented strand board, can have a thickness or average thickness of about 1.5 mm, about 5 mm, or about 10 mm to about 15 mm, about 20 mm, about 25 mm, about 30 mm, about 50 mm, about 100 mm, about 200 mm, or about 300 mm. Composite products such as particleboard, fiberboard, plywood, and oriented strand board can have a length of about 0.1 m, about 0.5 m, about 1 m, about 1.2 m, about 1.8 m, about 2.4 m, about 3 m, or about 3.6 m. The composite products can also have a width of about 0.1 m, about 0.5 m, about 1 m, about 1.2 m, about 1.8 m, about 2.4 m, or about 3 m.

In some examples, the resinated furnish can be heated to a temperature of at least 60° C. to about 300° C. for about 0.1 min to about 30 min to produce the composite product. In other example, the resinated furnish can be heated to a temperature of at least 60° C. to about 300° C. for about 0.1 min to about 30 min, or a temperature of about 80° C. to about 250° C. for about 0.3 min to about 20 min, or a temperature of about 100° C. to about 200° C. for about 0.5 min to about 10 min, or a temperature of about 120° C. to about 180° C. for about 1 min to about 10 min, or a temperature of about 130° C. to about 170° C. for about 1 min to about 5 min; or a temperature of about 140° C. to about 160° C. for about 1 min to about 4 min. In other examples, the resinated furnish can be pressed while heating the resinated furnish to produce the composite product. In some examples, the resinated furnish can be pressed at a pressure of about 0.5 MPa to about 15 MPa.

In other examples, prior to heating the resinated furnish, the resinated furnish can be maintained at a desired temperature for a desired amount of time. For example, the resinated furnish can be maintained at a temperature of less than 60° C. for at least 10 min to about 240 min, or a temperature of less than 50° C. for at least 30 min to about 120 min, or a temperature of less than 40° C. for at least 30 min to about 90 min, or a temperature of less than 40° C. for at least 30 min to about 60 min, or at a temperature of less than 35° C. for at least 30 min to about 60 min.

### EXAMPLES

In order to provide a better understanding of the foregoing discussion, the following non-limiting examples are offered. Although the examples may be directed to specific embodiments, they are not to be viewed as limiting the invention in any specific respect. All parts, proportions, and percentages are by weight unless otherwise indicated.

### Example 1

### Kraft Lignin Mixture

To a blend tank equipped with an agitator, about 60 g of water and about 33.4 g of kraft lignin wet cake (DCL200 dewatered lignin, as obtained from Domtar, Inc., which contained about 65 wt % solid lignin and about 35 wt % water) were added and mixed therein. About 2.2 g of aqueous sodium lignosulfonate solution (ARBO® S01, as obtained from Tembec Industries, Inc., that contained about 50 wt % of solid sodium lignosulfonate and about 50 wt % of water), and about 4.4 g of aqueous sodium hydroxide solution (about 50 wt % of solid sodium hydroxide and about 50 wt % of water) were added to the mixture in the blend tank and the mixture was allowed to exotherm to about 80° C. To the mixture, additional aqueous sodium hydroxide solution was added to the mixture in the blend tank to adjust the pH of the mixture to about 11.4. The mixture was maintained at a temperature of about 80° C. and agitated for about 3 hours to produce the kraft lignin mixture. The kraft lignin mixture was cooled to room temperature (about 25° C.) and discharged into a container. The kraft lignin mixture had a solids content of about 25 wt %.

### Example 2

### Adhesive (with Kraft Lignin and Lignosulfonate)

To a blend tank equipped with an agitator, about 33 g of aqueous phenol-formaldehyde resin (GP RESI-BOND® 5772 plywood neat resin, as obtained from Georgia-Pacific Chemicals LLC), about 1 g of phenol-formaldehyde resin powder (WOODWELD® 190C42 spray-dried OSB adhesive, as obtained from Georgia-Pacific Chemicals LLC), about 5.5 g of corn flour (NCS83 corn flour, as obtained from Plybond), about 0.2 g of wheat flour (GLU-X® wheat flour, as obtained from Siemer Milling Company, Teutopolis, Ill.) were added and the components were agitated for about 3 min, then agitation was stopped. About 6.6 g of water, about 7.7 g of corn cob residue (WILVACO-FIL corn cob residue, as obtained from Wilvaco), about 16.2 g of the kraft lignin mixture (as prepared in Example 1) were added to the mixture in the blend tank and mixture was agitated for about 3 min, then agitation was stopped. About 2.9 g of aqueous sodium hydroxide solution (about 50 wt % of solid sodium hydroxide and about 50 wt % of water) and about 1.1 g of soda ash were added to the mixture in the blender tank and the mixture was agitated for about 12 min, then agitation was stopped. About 25.8 g of additional phenol-formaldehyde resin (GP REST-BOND® 5772 plywood neat resin) was added to the mixture in the blend tank and the mixture was agitated for about 2 min, agitation was stopped, and the adhesive was discharged into a container. The adhesive had a solids content of about 42 wt % to about 46 wt %.

### Comparative Example 3

### Control Adhesive (with No Lignin and No Lignosulfonate)

To a blend tank equipped with an agitator, about 30 g of aqueous phenol-formaldehyde resin (GP REST-BOND® 5772 plywood neat resin), about 1 g of phenol-formaldehyde resin powder (WOODWELD® 190C42 spray-dried OSB adhesive), about 5.5 g of corn flour (NCS83 corn flour), about 0.2 g of wheat flour (GLU-X® wheat flour) were added and the components were agitated for about 3 min, then agitation was stopped. About 18.8 g of water, about 7.7 g of corn cob residue (WILVACO-FIL® corn cob residue) were added to the mixture in the blend tank and the mixture was agitated for about 3 min, then agitation was stopped. About 2.9 g of aqueous sodium hydroxide solution (about 50 wt % of solid sodium hydroxide and about 50 wt % of water) and about 1.1 g of soda ash were added to the mixture in the blend tank and the mixture was agitated for about 12 min, then agitation was stopped. About 32.8 g of phenol-formaldehyde resin (GP RESI-BOND® 5772 plywood neat resin) was added to the mixture in the blend tank and the mixture was agitated for about 2 min, agitation was stopped, and the control adhesive was discharged into a container. The control adhesive (with no kraft lignin and no lignosulfonate) had a solids content of about 42 wt % to about 46 wt %.

### Comparative Example 4

### Control Adhesive (with Kraft Lignin, but no Lignosulfonate)

To a blend tank equipped with an agitator, about 19.4 g of water, about 4.9 g of corn flour (NCS83 corn flour), about 2.6 g of wheat flour (GLU-X® wheat flour), and about 3.2 g of kraft lignin (about 60 wt % lignin and 40 wt % water supplied by Domtar) were added and the components were agitated for about 3 min, then agitation was stopped. About 27 g of phenol-formaldehyde resin (GP RESI-BOND® 5772 plywood neat resin), about 0.6 g of aqueous sodium hydroxide solution (about 50 wt % of solid sodium hydroxide and about 50 wt % of water), and about 7.3 g of crushed walnut shell media were added to the mixture in the blend tank and the mixture was agitated for about 2 min, then agitation was stopped. About 1 g of soda ash and about 3 g of aqueous sodium hydroxide solution (about 50 wt % of solid sodium hydroxide and about 50 wt % of water) were added to the mixture in the blend tank and the mixture was agitated for about 10 min, then agitation was stopped. About 28.4 g of phenol-formaldehyde resin (GP REST-BOND® 5772 plywood neat resin), about 0.6 g of sodium hydroxide (solid), and about 3.2 g of kraft lignin (about 60 wt % lignin and 40 wt % water supplied by Domtar) were added to the mixture in the blend tank and the mixture was agitated for about 5 min, agitation was stopped, and the control adhesive was discharged into a container. The control adhesive (with kraft lignin but no lignosulfonate) had a solids content of about 43 wt %.

The viscosities at 25° C. of the adhesives prepared in Example 2 and Comparative Examples 3 and 4 were tested at the time the adhesives were prepared and at about 24 hours after the time of preparation. The adhesives were all maintained at a temperature of about 25° C. from the time the adhesives were prepared to about 24 hours after the time of preparation when the viscosity was measured again. Table 1 shows the viscosities for the adhesives prepared in Example 2 and Comparative Example 3 and 4. As shown in Table 1, the viscosity of the adhesive prepared in Example 2, which included the kraft lignin and the lignosulfonate, surprisingly and unexpectedly had a significantly greater viscosity stability over at least 24 hours as compared to the comparative adhesive in Comparative Example 4, which included the kraft lignin, but no lignosulfonate.

TABLE 1
Viscosity Stability

| | Ex. 2 | Comp. Ex. 3 | Comp. Ex. 4 |
|---|---|---|---|
| Elapsed Time | viscosity (cP) | viscosity (cP) | viscosity (cP) |
| At time of | 1,880 | 1,600 | 2,800 |
| preparation | | | |
| At about 24 hr from | 2,060 | 1,860 | 6,200 |
| time of preparation | | | |

### Example 5

### Plywood Preparation

Plywood was made with adhesive formulations from Example 2 and Comparative Example 3. The plywood was made as five ply using southern yellow pine veneer that had a thickness of about ⅛in (about 3.2 mm). The adhesive spread was about 15 g/ft² and the adhesive was applied using a roll coater, available from Black Brothers, Inc. Five plies of the veneer were stacked and pressed in a Wabash press with a platen temperature of about 330° F. (about 166° C.) until the adhesive was fully cured. Plywood made with adhesives from Example 2 and Comparative Example 3 both had greater than 70% rate of wood failure which exceeds the minimum requirement set by the American Plywood Association.

Embodiments of the present disclosure further relate to any one or more of the following paragraphs:

1. An adhesive, comprising: an aldehyde-based resin, a kraft lignin, a surfactant, an alkaline compound; and water, wherein the adhesive has a viscosity of about 500 cP to about 4,000 cP, at a temperature of about 25° C.

2. The adhesive of paragraph 1, wherein the surfactant comprises an anionic surfactant, a cationic surfactant, a nonionic surfactant, or any mixture thereof.

3. The adhesive of paragraph 1, wherein the surfactant comprises a lignosulfonate, and wherein the lignosulfonate comprises sodium lignosulfonate, lithium lignosulfonate, potassium lignosulfonate, calcium lignosulfonate, magnesium lignosulfonate, ammonium lignosulfonate, salts thereof, complexes thereof, or any mixture thereof.

4. The adhesive of any one of paragraphs 1 to 3, wherein the adhesive has a viscosity of about 500 cP to about 3,500 cP, at a temperature of about 25° C., for a period of time of about 1 day to about 20 days, and wherein the period of time starts when the adhesive is initially produced.

5. The adhesive of any one of paragraphs 1 to 4, wherein the adhesive has a secondary viscosity of greater than an initial viscosity to less than 150% of the initial viscosity, wherein the secondary viscosity is measured 24 hours from the time of production of the adhesive at a temperature of about 25° C.

6. The adhesive of any one of paragraphs 1 to 5, wherein the adhesive comprises about 50 wt % to about 80 wt % of the aldehyde-based resin, about 2 wt % to about 15 wt % of the kraft lignin, about 0.05 wt % to about 5 wt % of the surfactant, about 1 wt % to about 15 wt % of the alkaline compound; and about 10 wt % to about 35 wt % of water, wherein all weight percent values are based on the combined weight of the aldehyde-based resin, the kraft lignin, the surfactant, the alkaline compound, and the water.

7. The adhesive of paragraph 6, further comprising an extender, a filler, and a salt, wherein the adhesive further comprises about 1 wt % to about 20 wt % of the extender, about 1 wt % to about 20 wt % of the filler; and about 0.1 wt % to about 10 wt % of the salt, wherein all weight percent values are based on the combined weight of the aldehyde-based resin, the kraft lignin, the surfactant, the alkaline compound, and the water.

8. The adhesive of any one of paragraphs 1 to 5, wherein the adhesive comprises about 2 wt % to about 25 wt % of the kraft lignin, about 0.08 wt % to about 4 wt % of the surfactant, about 1 wt % to about 20 wt % of the alkaline compound; and about 20 wt % to about 50 wt % of water, wherein all weight percent values are based on the solids weight of the aldehyde-based resin.

9. The adhesive of paragraph 8, further comprising an extender, a filler, and a salt, wherein the adhesive comprises about 2 wt % to about 25 wt % of the kraft lignin, about 0.08 wt % to about 4 wt % of the surfactant, about 1 wt % to about 20 wt % of the alkaline compound, about 5 wt % to about 30 wt % of the extender, about 5 wt % to about 30 wt % of the filler, about 0.2 wt % to about 8 wt % of the salt; and about 20 wt % to about 50 wt % of water, wherein all weight percent values are based on the solids weight of the aldehyde-based resin.

10. The adhesive of any one of paragraphs 1 to 5, further comprising an extender, a filler, and a salt, wherein the adhesive comprises about 40 wt % to about 70 wt % of the aldehyde-based resin, about 1 wt % to about 15 wt % of the kraft lignin, about 0.05 wt % to about 3 wt % of the surfactant, about 0.8 wt % to about 12 wt % of the alkaline compound, about 1 wt % to about 20 wt % of the extender, about 1 wt % to about 20 wt % of the filler, about 0.1 wt % to about 5 wt % of the salt; and about 5 wt % to about 35 wt % of water, wherein all weight percent values are based on the combined weight of the aldehyde-based resin, the kraft lignin, the surfactant, the alkaline compound, the extender, the filler, the salt, and the water.

11. The adhesive of any one of paragraphs 1 to 5, further comprising an extender, a filler, and a salt, wherein the adhesive comprises about 50 wt % to about 60 wt % of the aldehyde-based resin, about 3 wt % to about 9 wt % of the kraft lignin, about 0.1 wt % to about 3 wt % of the surfactant, about 1 wt % to about 10 wt % of the alkaline compound, about 5 wt % to about 15 wt % of the extender, about 5 wt % to about 15 wt % of the filler, about 0.1 wt % to about 2 wt % of the salt; and about 15 wt % to about 25 wt % of water, wherein all weight percent values are based on the combined weight of the aldehyde-based resin, the kraft lignin, the surfactant, the alkaline compound, the extender, the filler, the salt, and the water.

12. The adhesive of any one of paragraphs 1 to 11, wherein: the aldehyde-based resin comprises a phenol-formaldehyde resin, a urea-formaldehyde resin, a resorcinol-formaldehyde resin, a phenol-resorcinol-formaldehyde resin, a phenol-urea-formaldehyde resin, a melamine-formaldehyde resin, a melamine-urea-formaldehyde resin, a phenol-melamine-formaldehyde resin, or any mixture thereof, the surfactant comprises sodium lignosulfonate, lithium lignosulfonate, potassium lignosulfonate, calcium lignosulfonate, magnesium lignosulfonate, ammonium lignosulfonate, salts thereof, or any mixture thereof, the extender comprises corn flour, wheat flour, soy flour, oat flour, or any mixture thereof, the alkaline compound comprises sodium hydroxide, potassium hydroxide, ammonium hydroxide, or any mixture thereof, the filler comprises corn cob media, nut shell media, or a mixture thereof, and the salt comprises sodium carbonate, potassium carbonate, calcium carbonate, lithium carbonate, ammonium carbonate, or any mixture thereof.

13. A method for making an adhesive, comprising combining a kraft lignin, a surfactant, and water to produce a kraft lignin mixture that has a pH value of about 10 or greater; and combining an aldehyde-based resin, an extender, and the kraft lignin mixture to produce an adhesive, wherein the adhesive has an initial viscosity of about 1,500 cP to about 2,500 cP, at a temperature of about 25° C.

14. The method of paragraph 13, wherein the adhesive has a secondary viscosity of greater than the initial viscosity to less than 150% of the initial viscosity, wherein the adhesive is maintained at a temperature of about 25° C. for about 24 hours from the time of producing of the adhesive, and wherein the secondary viscosity is measured 24 hours from the time of producing of the adhesive at a temperature of about 25° C.

15. The method of paragraph 14, wherein the secondary viscosity is about 1,600 cP to about 3,000 cP, at a temperature of about 25° C.

16. The method of any one of paragraphs 13 to 15, further comprising combining an alkaline compound with the kraft lignin, the surfactant, and water to form the kraft lignin mixture, wherein the kraft lignin mixture has a pH of about 10 to about 12.5, and maintaining the kraft lignin mixture at a temperature of about 60° C. to about 120° C. for at least 1 hour.

17. The method of paragraph 16, further comprising maintaining the aqueous mixture at a temperature of about 60° C. to about 120° C. for about 1 hour to about 6 hours

18. The method of any one of paragraphs 13 to 17, wherein the kraft lignin mixture further comprises an alkaline compound, and wherein the kraft lignin mixture comprises: about 70 wt % to about 98 wt % of the kraft lignin, about 1 wt % to about 12 wt % of the surfactant; and about 2 wt % to about 25 wt % of the alkaline compound, wherein all weight percent values are based on the combined weight of the kraft lignin, the surfactant, and the alkaline compound.

19. The method of any one of paragraphs 13 to 18, wherein the surfactant comprises sodium lignosulfonate, lithium lignosulfonate, potassium lignosulfonate, calcium lignosulfonate, magnesium lignosulfonate, ammonium lignosulfonate, salts thereof, or any mixture thereof wherein the aldehyde-based resin comprises a phenol-formaldehyde resin, a urea-formaldehyde resin, a resorcinol-formaldehyde resin, a phenol-resorcinol-formaldehyde resin, a phenol-urea-formaldehyde resin, a melamine-formaldehyde resin, a melamine-urea-formaldehyde resin, a phenol-melamine-formaldehyde resin, or any mixture thereof; and wherein the extender comprises corn flour, wheat flour, soy flour, oat flour, or any mixture thereof.

20. The method of any one of paragraphs 13 to 19, wherein the adhesive comprises: about 2 wt % to about 25 wt % of the kraft lignin, about 0.08 wt % to about 4 wt % of the surfactant, about 5 wt % to about 30 wt % of the extender; and about 20 wt % to about 50 wt % of water, wherein all weight percent values are based on the solids weight of the aldehyde-based resin.

21. The method of paragraph 13, wherein the adhesive further comprises an alkaline compound, a filler, and a salt, and wherein the adhesive comprises about 40 wt % to about 70 wt % of the aldehyde-based resin, about 1 wt % to about 15 wt % of the kraft lignin, about 0.05 wt % to about 3 wt % of the surfactant, about 0.8 wt % to about 12 wt % of the alkaline compound, about 1 wt % to about 20 wt % of the extender, about 1 wt % to about 20 wt % of the filler, about 0.1 wt % to about 5 wt % of the salt; and about 5 wt % to about 35 wt % of water, wherein all weight percent values are based on the combined weight of the aldehyde-based resin, the kraft lignin, the surfactant, the alkaline compound, the extender, the filler, the salt, and the water.

22. The method of any one of paragraphs 13 to 20, further comprising: combining the aldehyde-based resin, the extender, the kraft lignin mixture, an alkaline compound, and water to form an aqueous mixture; and agitating the aqueous mixture to form the adhesive.

23. The method of paragraph 22, further comprising combining a filler and a salt with the aldehyde-based resin, the extender, the kraft lignin mixture, the alkaline compound, and water to form the aqueous mixture, wherein the filler comprises corn cob media, nut shell media, or a mixture thereof, and wherein the salt comprises sodium carbonate, potassium carbonate, calcium carbonate, lithium carbonate, ammonium carbonate, or any mixture thereof.

24. The method of any one of paragraphs 13 to 23, wherein the kraft lignin mixture comprises about 1 wt % to about 10 wt % of the surfactant, based on the combined weight of the kraft lignin and the surfactant.

25. The method of any one of paragraphs 13 to 24, wherein the kraft lignin mixture comprises about 90 wt % to about 99 wt % of the kraft lignin, based on the combined weight of the kraft lignin and the surfactant.

26. The method of any one of paragraphs 13 to 25, wherein the kraft lignin mixture further comprises an alkaline compound, and wherein the kraft lignin mixture comprises: about 10 wt % to about 50 wt % of the kraft lignin, about 0.1 wt % to about 5 wt % of the surfactant; and about 0.5 wt % to about 10 wt % of the alkaline compound, wherein all weight percent values are based on the combined weight of the kraft lignin, the surfactant, the alkaline compound, and the water.

27. A method for making a composite product, comprising: combining a kraft lignin, a surfactant, and water to produce a kraft lignin mixture that has a pH of about 10 or greater; combining an aldehyde-based resin, an extender, and the kraft lignin mixture to produce an adhesive, wherein the adhesive has a viscosity of about 500 cP to about 5,000 cP, at a temperature of about 25° C.; combining a plurality of lignocellulose substrates and the adhesive; and at least partially curing the adhesive to produce a composite product comprising the plurality of lignocellulose substrates and the at least partially cured adhesive.

28. The method of paragraph 27, wherein the surfactant comprises an anionic surfactant, a cationic surfactant, a nonionic surfactant, or any mixture thereof.

29. The method of paragraph 27 or 28, wherein the surfactant comprises a lignosulfonate, and wherein the lignosulfonate comprises sodium lignosulfonate, lithium lignosulfonate, potassium lignosulfonate, calcium lignosulfonate, magnesium lignosulfonate, ammonium lignosulfonate, salts thereof, complexes thereof, or any mixture thereof.

30. The method of any one of paragraphs 27 to 29, wherein the plurality of lignocellulose substrates comprises wood sheets and the adhesive is disposed between the wood sheets.

31. The method of any one of paragraphs 27 to 30, further comprising: forming a resinated furnish by combining the plurality of lignocellulose substrates and the adhesive; and heating the resinated furnish to produce the composite product.

32. The method of any one of paragraphs 27 to 31, wherein the composite product is plywood, oriented strand board, laminated veneer lumber, laminated veneer boards, engineered wood flooring, particleboard, fiberboard, or any mixture thereof.

33. An adhesive, comprising: an aldehyde-based resin; a kraft lignin; a surfactant; an alkaline compound; and water, wherein the adhesive has a viscosity of about 500 cP to about 5,000 cP, at a temperature of about 25° C.

34. A resinated furnish, comprising: a plurality of lignocellulose substrates; and an adhesive, wherein the adhesive comprises: about 20 wt % to about 40 wt % of an aldehyde-based resin, about 1 wt % to about 15 wt % of a kraft lignin, about 0.05 wt % to about 2 wt % of a surfactant, about 0.5 wt % to about 10 wt % of an alkaline compound, and about 45 wt % to about 70 wt % of water, wherein all weight percent values are based on a combined weight of the aldehyde-based resin, the kraft lignin, the surfactant, the alkaline compound, and the water, and wherein the adhesive has a viscosity of about 500 cP to about 5,000 cP, at a temperature of about 25° C.

35. The adhesive according to paragraph 33, wherein the adhesive comprises: about 20 wt % to about 40 wt % of the aldehyde-based resin, about 1 wt % to about 15 wt % of the kraft lignin, about 0.05 wt % to about 2 wt % of the surfactant, about 0.5 wt % to about 10 wt % of the alkaline compound, and about 45 wt % to about 70 wt % of water, wherein all weight percent values are based on a combined weight of the aldehyde-based resin, the kraft lignin, the surfactant, the alkaline compound, and the water.

36. The adhesive or resonated furnish according to any one of paragraphs 33 to 35, further comprising an extender, a filler, a salt, or any mixture thereof.

37. The adhesive or resonated furnish according to paragraph 36, wherein the adhesive comprises: about 20 wt % to about 40 wt % of the aldehyde-based resin, about 1 wt % to about 15 wt % of the kraft lignin, about 0.05 wt % to about 2 wt % of the surfactant, about 0.5 wt % to about 10 wt % of the alkaline compound, up to about 10 wt % of the extender, up to about 10 wt % of the filler, up to about 5 wt % of the salt, and about 45 wt % to about 70 wt % of water, wherein all weight percent values are based on a combined weight of the aldehyde-based resin, the kraft lignin, the surfactant, the alkaline compound, the extender, the filler, the salt, and the water.

38. The adhesive or resonated furnish according to any one of paragraphs 33 to 37, wherein the surfactant comprises an anionic surfactant, a cationic surfactant, a nonionic surfactant, or any mixture thereof.

39. The adhesive or resonated furnish according to any one of paragraphs 33 to 38, wherein the surfactant comprises sodium lignosulfonate, lithium lignosulfonate, potassium lignosulfonate, calcium lignosulfonate, magnesium lignosulfonate, ammonium lignosulfonate, salts thereof, complexes thereof, or any mixture thereof.

40. The adhesive or resonated furnish according to any one of paragraphs 33 to 39, wherein the aldehyde-based resin comprises a phenol-formaldehyde resin, a urea-formaldehyde resin, a resorcinol-formaldehyde resin, a phenol-resorcinol-formaldehyde resin, a phenol-urea-formaldehyde resin, a melamine-formaldehyde resin, a melamine-urea-formaldehyde resin, a phenol-melamine-formaldehyde resin, or any mixture thereof.

41. The adhesive or resonated furnish according to any one of paragraphs 33 to 40, wherein the alkaline compound comprises sodium hydroxide, potassium hydroxide, ammonium hydroxide, or any mixture thereof.

42. The adhesive or resonated furnish according to any one of paragraphs 33 to 41, wherein the adhesive has a viscosity of about 500 cP to about 4,000 cP, at a temperature of about 25° C., for a period of time of at least 1 day, and wherein the period of time starts when the adhesive is initially produced.

43. The adhesive or resonated furnish according to any one of paragraphs 33 to 42, wherein the adhesive has a viscosity of about 500 cP to about 3,500 cP at a temperature of about 25° C., for a period of time of about 1 day to about 20 days, and wherein the period of time starts when the adhesive is initially produced.

44. The adhesive or resonated furnish according to any one of paragraphs 33 to 43, wherein the adhesive has a secondary viscosity of greater than an initial viscosity to less than 150% of the initial viscosity, wherein the secondary viscosity is measured 24 hours from the time of production of the adhesive at a temperature of about 25° C.

45. The adhesive or resonated furnish according to any one of paragraphs 36 to 44, wherein the extender, if present, comprises corn flour, wheat flour, soy flour, oat flour, or any mixture thereof.

46. The adhesive or resonated furnish according to any one of paragraphs 36 to 45, wherein the filler, if present, comprises corn cob media, nut shell media, or a mixture thereof.

47. The adhesive or resonated furnish according to any one of paragraphs 36 to 46, wherein the salt, if present, comprises sodium carbonate, potassium carbonate, calcium carbonate, or any mixture thereof.

48. An adhesive, comprising: about 20 wt % to about 40 wt % of a phenol-formaldehyde resin; about 1 wt % to about 10 wt % of a kraft lignin; about 0.05 wt % to about 1 wt % of a lignosulfonate; about 0.5 wt % to about 5 wt % of an alkaline compound; and about 50 wt % to about 65 wt % of water, wherein all weight percent values are based on a combined weight of the phenol-formaldehyde resin, the kraft lignin, the surfactant, the alkaline compound, and the water, and wherein the adhesive has a viscosity of about 500 cP to about 4,000 cP, at a temperature of about 25° C., for a period of time of at least 1 day, and wherein the period of time starts when the adhesive is initially produced.

49. The adhesive according to paragraph 48, further comprising an extender, a filler, a salt, or any mixture thereof.

50. The adhesive according to paragraph 49, wherein the adhesive comprises: about 20 wt % to about 30 wt % of the phenol-formaldehyde resin, about 1 wt % to about 10 wt % of the kraft lignin, about 0.05 wt % to about 1 wt % of the lignosulfonate, about 0.5 wt % to about 5 wt % of the alkaline compound, about 1 wt % to about 10 wt % of the extender, about 1 wt % to about 10 wt % of the filler, about 1 wt % to about 2 wt % of the salt, and about 50 wt % to about 60 wt % of water, wherein all weight percent values are based on a combined weight of the aldehyde-based resin, the kraft lignin, the surfactant, the alkaline compound, the extender, the filler, the salt, and the water.

51. The adhesive according to paragraph 49, wherein the adhesive comprises: about 20 wt % to about 30 wt % of the phenol-formaldehyde resin, about 1 wt % to about 7 wt % of the kraft lignin, about 0.05 wt % to about 0.7 wt % of the lignosulfonate, about 0.5 wt % to about 4 wt % of the alkaline compound, about 1 wt % to about 10 wt % of the extender, about 1 wt % to about 10 wt % of the filler, about 1 wt % to about 2 wt % of the salt, and about 50 wt % to about 60 wt % of water, wherein all weight percent values are based on a combined weight of the aldehyde-based resin, the kraft lignin, the surfactant, the alkaline compound, the extender, the filler, the salt, and the water.

52. The adhesive according to any one of paragraphs 48 to 51, wherein the lignosulfonate comprises sodium lignosulfonate, lithium lignosulfonate, potassium lignosulfonate, calcium lignosulfonate, magnesium lignosulfonate, ammonium lignosulfonate, salts thereof, or any mixture thereof.

53. The adhesive according to any one of paragraphs 48 to 52, wherein the alkaline compound comprises sodium hydroxide, potassium hydroxide, ammonium hydroxide, or any mixture thereof.

54. The adhesive according to any one of paragraphs 49 to 53, wherein the adhesive comprises the extender, and wherein the extender comprises corn flour, wheat flour, soy flour, oat flour, or any mixture thereof.

55. The adhesive according to any one of paragraphs 49 to 54, wherein the adhesive comprises the filler, and wherein the filler comprises corn cob media, nut shell media, or a mixture thereof.

56. The adhesive according to any one of paragraphs 49 to 55, wherein the adhesive comprises the salt, and wherein the salt comprises sodium carbonate, potassium carbonate, calcium carbonate, or any mixture thereof.

57. The adhesive according to any one of paragraphs 48 to 56, wherein the adhesive has a viscosity of about 500 cP to about 3,500 cP at a temperature of about 25° C., for a period of time of about 1 day to about 20 days, and wherein the period of time starts when the adhesive is initially produced.

58. The adhesive according to any one of paragraphs 48 to 57, wherein the adhesive has a secondary viscosity of greater than an initial viscosity to less than 150% of the initial viscosity, wherein the secondary viscosity is measured 24 hours from the time of production of the adhesive at a temperature of about 25° C.

59. A method for making a composite product, comprising: contacting a plurality of lignocellulose substrates with an adhesive to produce a resinated furnish, wherein the adhesive comprises an aldehyde-based resin, a kraft lignin, a surfactant, an alkaline compound, and water, and wherein the adhesive has a viscosity of about 500 cP to about 5,000 cP at a temperature of about 25° C.; and at least partially curing the aldehyde-based resin in the resinated furnish to produce a composite product.

60. The method according to paragraph 59, wherein the adhesive comprises: about 20 wt % to about 40 wt % of the aldehyde-based resin, about 1 wt % to about 15 wt % of the kraft lignin, about 0.05 wt % to about 2 wt % of the surfactant, about 0.5 wt % to about 10 wt % of the alkaline compound; and about 45 wt % to about 70 wt % of water, wherein all weight percent values are based on a combined weight of the aldehyde-based resin, the kraft lignin, the surfactant, the alkaline compound, and the water.

61. The method according to paragraph 59 or 60, wherein the adhesive further comprises an extender, a filler, a salt, or any mixture thereof.

62. The method according to paragraph 61, wherein the adhesive comprises: about 20 wt % to about 40 wt % of the aldehyde-based resin, about 1 wt % to about 15 wt % of the kraft lignin, about 0.05 wt % to about 2 wt % of the surfactant, about 0.5 wt % to about 10 wt % of the alkaline compound, up to about 10 wt % of the extender, up to about 10 wt % of the filler, up to about 5 wt % of the salt, and about 45 wt % to about 70 wt % of water, wherein all weight percent values are based on a combined weight of the aldehyde-based resin, the kraft lignin, the surfactant, the alkaline compound, the extender, the filler, the salt, and the water.

63. The method according to any one of paragraphs 59 to 62, wherein the surfactant comprises an anionic surfactant, a cationic surfactant, a nonionic surfactant, or any mixture thereof.

64. The method according to any one of paragraphs 59 to 63, wherein the surfactant comprises sodium lignosulfonate, lithium lignosulfonate, potassium lignosulfonate, calcium lignosulfonate, magnesium lignosulfonate, ammonium lignosulfonate, salts thereof, complexes thereof, or any mixture thereof.

65. The method according to any one of paragraphs 59 to 64, wherein the aldehyde-based resin comprises a phenol-formaldehyde resin, a urea-formaldehyde resin, a resorcinol-formaldehyde resin, a phenol-resorcinol-formaldehyde resin, a phenol-urea-formaldehyde resin, a melamine-formaldehyde resin, a melamine-urea-formaldehyde resin, a phenol-melamine-formaldehyde resin, or any mixture thereof.

66. The method according to any one of paragraphs 59 to 65, wherein the alkaline compound comprises sodium hydroxide, potassium hydroxide, ammonium hydroxide, or any mixture thereof.

67. The method according to any one of paragraphs 59 to 66, wherein the adhesive has a viscosity of about 500 cP to about 4,000 cP, at a temperature of about 25° C., for a period of time of at least 1 day, and wherein the period of time starts when the adhesive is initially produced.

68. The method according to any one of paragraphs 59 to 67, wherein the adhesive has a viscosity of about 500 cP to about 3,500 cP at a temperature of about 25° C., for a period of time of about 1 day to about 20 days, and wherein the period of time starts when the adhesive is initially produced.

69. The method according to any one of paragraphs 59 to 68, wherein the adhesive has a secondary viscosity of greater than an initial viscosity to less than 150% of the initial viscosity, wherein the secondary viscosity is measured 24 hours from the time of production of the adhesive at a temperature of about 25° C.

70. A method for making a lignin mixture, comprising combining a kraft lignin, a surfactant, an alkaline compound, and water to produce a kraft lignin mixture that has a pH of about 10 or greater.

71. A lignin mixture, comprising: a kraft lignin; a surfactant; an alkaline compound; and water, wherein the kraft lignin mixture has a pH of about 10 or greater.

72. The method or mixture according to paragraph 70 or 71, wherein the surfactant comprises an anionic surfactant, a cationic surfactant, a nonionic surfactant, or any mixture thereof.

73. The method or mixture according to paragraph 70 or 71, wherein the surfactant comprises sodium lignosulfonate, lithium lignosulfonate, potassium lignosulfonate, calcium lignosulfonate, magnesium lignosulfonate, ammonium lignosulfonate, salts thereof, complexes thereof, or any mixture thereof.

74. The method or mixture according to any one of paragraphs 70 to 73, wherein the alkaline compound comprises sodium hydroxide, potassium hydroxide, ammonium hydroxide, or any mixture thereof.

75. The method or mixture according to any one of paragraphs 70 to 74, wherein the kraft lignin mixture comprises about 10 wt % to about 35 wt % of the kraft lignin, about 0.1 wt % to about 3 wt % of the surfactant, about 0.5 wt % to about 5 wt % of the alkaline compound, and about 55 wt % to about 85 wt % of water, where all weight percent values are based on the combined weight of the kraft lignin, the surfactant, the alkaline compound, and the water.

76. The method or mixture according to any one of paragraphs 70 to 74, wherein the kraft lignin mixture comprises about 15 wt % to about 25 wt % of the kraft lignin, about 0.5 wt % to about 2 wt % of the surfactant, about 1 wt % to about 3 wt % of the alkaline compound, and about 70 wt % to about 80 wt % of water, where all weight percent values are based on the combined weight of the kraft lignin, the surfactant, the alkaline compound, and the water.

77. The method or mixture according to any one of paragraphs 70 to 76, wherein the kraft lignin mixture has a pH of about 10 to about 12.5.

78. The method or mixture according to any one of paragraphs 70 to 77, wherein the kraft lignin mixture has a pH of about 10.5 to about 12.5.

79. The method or mixture according to any one of paragraphs 70 to 78, wherein the kraft lignin mixture has a pH of about 11 to about 12.5.

80. The method or mixture according to any one of paragraphs 70 to 79, wherein the kraft lignin mixture has a pH of at least 11 to about 12.5.

81. The method or mixture according to any one of paragraphs 70 to 80, wherein the kraft lignin mixture has a solids content of about 15 wt % to about 35 wt %.

82. The method or mixture according to any one of paragraphs 70 to 80, wherein the kraft lignin mixture has a solids content of about 20 wt % to about 30 wt %.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. An adhesive, comprising:
an aldehyde-based resin;
a kraft lignin;
a surfactant;
an alkaline compound; and
water, wherein the adhesive has a viscosity of about 500 cP to about 5,000 cP at a temperature of about 25° C.

2. The adhesive of claim 1, wherein the adhesive has a viscosity of about 500 cP to about 4,000 cP at a temperature of about 25° C., for a period of time of at least 1 day, and wherein the period of time starts when the adhesive is initially produced.

3. The adhesive of claim 1, wherein the adhesive has a viscosity of about 500 cP to about 3,500 cP at a temperature of about 25° C., for a period of time of about 1 day to about 20 days, and wherein the period of time starts when the adhesive is initially produced.

4. The adhesive of claim 1, wherein the adhesive has a secondary viscosity of greater than an initial viscosity to less than 150% of the initial viscosity, and wherein the secondary viscosity is measured 24 hours from the time of production of the adhesive at a temperature of about 25° C.

5. The adhesive of claim 1, wherein the adhesive comprises:
about 20 wt % to about 40 wt % of the aldehyde-based resin,
about 1 wt % to about 15 wt % of the kraft lignin,
about 0.05 wt % to about 2 wt % of the surfactant,
about 0.5 wt % to about 10 wt % of the alkaline compound, and
about 45 wt % to about 70 wt % of water, wherein all weight percent values are based on a combined weight of the aldehyde-based resin, the kraft lignin, the surfactant, the alkaline compound, and the water.

6. The adhesive of claim 1, wherein the surfactant comprises an anionic surfactant, a cationic surfactant, a nonionic surfactant, or any mixture thereof.

7. The adhesive of claim 1, wherein the surfactant comprises sodium lignosulfonate, lithium lignosulfonate, potassium lignosulfonate, calcium lignosulfonate, magnesium lignosulfonate, ammonium lignosulfonate, salts thereof, complexes thereof, or any mixture thereof.

8. The adhesive of claim 1, wherein:
the aldehyde-based resin comprises a phenol-formaldehyde resin, a urea-formaldehyde resin, a resorcinol-formaldehyde resin, a phenol-resorcinol-formaldehyde resin, a phenol-urea-formaldehyde resin, a melamine-formaldehyde resin, a melamine-urea-formaldehyde resin, a phenol-melamine-formaldehyde resin, or any mixture thereof,
the surfactant comprises sodium lignosulfonate, lithium lignosulfonate, potassium lignosulfonate, calcium lignosulfonate, magnesium lignosulfonate, ammonium lignosulfonate, salts thereof, or any mixture thereof, and
the alkaline compound comprises sodium hydroxide, potassium hydroxide, ammonium hydroxide, or any mixture thereof.

9. The adhesive of claim 1, further comprising an extender, a filler, a salt, or any mixture thereof.

10. The adhesive of claim 9, wherein the adhesive comprises:
about 20 wt % to about 40 wt % of the aldehyde-based resin,
about 1 wt % to about 15 wt % of the kraft lignin,
about 0.05 wt % to about 2 wt % of the surfactant,
about 0.5 wt % to about 10 wt % of the alkaline compound,
up to about 10 wt % of the extender,
up to about 10 wt % of the filler,
up to about 5 wt % of the salt, and
about 45 wt % to about 70 wt % of water, wherein all weight percent values are based on a combined weight of the aldehyde-based resin, the kraft lignin, the surfactant, the alkaline compound, the extender, the filler, the salt, and the water.

11. The adhesive of claim 10, wherein:
the aldehyde-based resin comprises a phenol-formaldehyde resin, a urea-formaldehyde resin, a resorcinol-formaldehyde resin, a phenol-resorcinol-formaldehyde resin, a phenol-urea-formaldehyde resin, a melamine-formaldehyde resin, a melamine-urea-formaldehyde resin, a phenol-melamine-formaldehyde resin, or any mixture thereof,
the surfactant comprises sodium lignosulfonate, lithium lignosulfonate, potassium lignosulfonate, calcium lignosulfonate, magnesium lignosulfonate, ammonium lignosulfonate, salts thereof, or any mixture thereof,
the alkaline compound comprises sodium hydroxide, potassium hydroxide, ammonium hydroxide, or any mixture thereof,
the extender, if present, comprises corn flour, wheat flour, soy flour, oat flour, or any mixture thereof,
the filler, if present, comprises corn cob media, nut shell media, or a mixture thereof, and
the salt, if present, comprises sodium carbonate, potassium carbonate, calcium carbonate, or any mixture thereof.

12. An adhesive, comprising:
about 20 wt % to about 40 wt % of a phenol-formaldehyde resin;
about 1 wt % to about 10 wt % of a kraft lignin;
about 0.05 wt % to about 1 wt % of a lignosulfonate;
about 0.5 wt % to about 5 wt % of an alkaline compound; and
about 50 wt % to about 65 wt % of water, wherein all weight percent values are based on a combined weight of the phenol-formaldehyde resin, the kraft lignin, the surfactant, the alkaline compound, and the water, wherein the adhesive has a viscosity of about 500 cP to about 4,000 cP at a temperature of about 25° C., for a period of time of at least 1 day, and wherein the period of time starts when the adhesive is initially produced.

13. The adhesive of claim 12, further comprising an extender, a filler, a salt, or any mixture thereof.

14. The adhesive of claim 13, wherein the adhesive comprises:
about 20 wt % to about 30 wt % of the phenol-formaldehyde resin,
about 1 wt % to about 7 wt % of the kraft lignin,
about 0.05 wt % to about 0.7 wt % of the lignosulfonate,
about 0.5 wt % to about 4 wt % of the alkaline compound,
about 1 wt % to about 10 wt % of the extender,
about 1 wt % to about 10 wt % of the filler,
about 1 wt % to about 2 wt % of the salt, and
about 50 wt % to about 60 wt % of water, wherein all weight percent values are based on a combined weight of the aldehyde-based resin, the kraft lignin, the surfactant, the alkaline compound, the extender, the filler, the salt, and the water.

15. The adhesive of claim 14, wherein:
the lignosulfonate comprises sodium lignosulfonate, lithium lignosulfonate, potassium lignosulfonate, calcium lignosulfonate, magnesium lignosulfonate, ammonium lignosulfonate, salts thereof, or any mixture thereof,
the alkaline compound comprises sodium hydroxide, potassium hydroxide, ammonium hydroxide, or any mixture thereof,
the extender comprises corn flour, wheat flour, soy flour, oat flour, or any mixture thereof,
the filler comprises corn cob media, nut shell media, or a mixture thereof, and
the salt comprises sodium carbonate, potassium carbonate, calcium carbonate, or any mixture thereof.

16. The adhesive of claim 12, wherein the adhesive has a viscosity of about 500 cP to about 3,500 cP at a temperature of about 25° C., for a period of time of about 1 day to about 20 days, and wherein the period of time starts when the adhesive is initially produced.

17. The adhesive of claim 12, wherein the adhesive has a secondary viscosity of greater than an initial viscosity to less than 150% of the initial viscosity, wherein the secondary viscosity is measured 24 hours from the time of production of the adhesive at a temperature of about 25° C.

18. A resinated furnish, comprising:
a plurality of lignocellulose substrates; and
an adhesive, wherein the adhesive comprises:
about 20 wt % to about 40 wt % of an aldehyde-based resin;
about 1 wt % to about 15 wt % of a kraft lignin;
about 0.05 wt % to about 2 wt % of a surfactant;
about 0.5 wt % to about 10 wt % of an alkaline compound; and
about 45 wt % to about 70 wt % of water, wherein all weight percent values are based on a combined weight of the aldehyde-based resin, the kraft lignin, the surfactant, the alkaline compound, and the water, and wherein the adhesive has a viscosity of about 500 cP to about 5,000 cP, at a temperature of about 25° C.

19. The resinated furnish of claim 18, wherein the adhesive has a viscosity of about 500 cP to about 3,500 cP, at a temperature of about 25° C., for a period of time of at least 1 day, and wherein the period of time starts when the adhesive is initially produced.

20. The adhesive of claim 18, further comprising an extender, a filler, a salt, or any mixture thereof, wherein the adhesive comprises:
about 20 wt % to about 40 wt % of the aldehyde-based resin;
about 1 wt % to about 15 wt % of the kraft lignin;
about 0.05 wt % to about 2 wt % of the surfactant;
about 0.5 wt % to about 10 wt % of the alkaline compound;
up to about 10 wt % of the extender;
up to about 10 wt % of the filler;
up to about 5 wt % of the salt; and
about 45 wt % to about 70 wt % of water, wherein all weight percent values are based on a combined weight of the aldehyde-based resin, the kraft lignin, the surfactant, the alkaline compound, the extender, the filler, the salt, and the water.
